(19) United States
(12) Patent Application Publication
(10) Pub. No.: US 2024/0049094 A1
(43) Pub. Date: Feb. 8, 2024

(54) MOBILITY ROBUSTNESS OPTIMIZATION ENHANCEMENT USING FALLBACK INDICATIONS FOR INTER-SYSTEM HANDOVER REPORTS

(71) Applicant: QUALCOMM Incorporated, San Diego, CA (US)

(72) Inventors: Shankar KRISHNAN, San Diego, CA (US); Rajeev KUMAR, San Diego, CA (US); Xipeng ZHU, San Diego, CA (US)

(21) Appl. No.: 18/351,851

(22) Filed: Jul. 13, 2023

Related U.S. Application Data
(60) Provisional application No. 63/370,727, filed on Aug. 8, 2022.

(51) Int. Cl. H04W 36/30

(52) U.S. Cl. CPC H04W 36/305

(57) ABSTRACT

A user equipment (UE) disconnects from next generation radio access network (NG-RAN) base station (BS) and receives, from the NG-RAN BS, a fallback indication. The UE then attempts to connect to an evolved-universal mobile telecommunications system terrestrial radio access network (E-UTRAN) BS. The UE determines that communication with the E-UTRAN BS was not established and identifies an alternate BS. After establishing communication with the alternate BS, the UE generates and transmits a report to the alternate BS including the fallback indication and information relating to the failed connection attempt with the E-UTRAN BS. The report is then conveyed to the NG-RAN BS for optimization of future fallback procedures.

### CROSS REFERENCE TO RELATED APPLICATIONS

This application claims the benefit of U.S. Provisional Application No. 63/370,727, filed Aug. 8, 2022, which is incorporated by reference herein.

### TECHNICAL FIELD

The present disclosure is directed to wireless communication systems and methods and more particularly to devices, systems, and methods for enhancing mobility robustness optimization (MRO) using fallback indications for inter-system handover reports.

### INTRODUCTION

Wireless communications systems are widely deployed to provide various types of communication content such as voice, video, packet data, messaging, broadcast, and so on. Due to the mobile nature of various wireless communications devices, such as user equipment (UE), as well as the allocation of different functions to different types of wireless communications devices, to provide mobile communication, a wireless communications device must transfer a wireless connection from one device to another. For example, a UE may be in wireless communication with a base station (BS). A handover procedure or redirection procedure may be implemented to disconnect the UE from the BS and connect to a different BS, referred to as fallback. A fallback may be performed in response to different causes, resulting in different types of fallbacks, such as a voice fallback, an emergency fallback, a fallback for load balancing, a fallback to address coverage issues, or other types.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

According to one aspect of the present disclosure, a method of wireless communication includes receiving a first signal by a first wireless communications device from a first next generation radio access network (NG-RAN) base station, the first signal including a fallback indication. The method further includes in response to receiving the first signal, transmitting a second signal by the first wireless communications device to a first evolved-universal mobile telecommunications system terrestrial radio access network (E-UTRAN) base station, the second signal including a connection request. The method further includes transmitting a third signal by the first wireless communications device to a second wireless communications device, the third signal including a report in response to a connection failure with the first E-UTRAN base station.

According to another aspect of the present disclosure, a method of wireless communications includes receiving a first signal by a first wireless communications device from a user equipment (UE), the first signal including a connection request. The method further includes transmitting a second signal by the first wireless communications device to the UE, the second signal including an information request. The method further includes receiving a third signal by the first wireless communications device from the UE, the third signal including a report generated in response to a failure to establish a connection between the UE and a second wireless communications device, the report comprising a fallback indication.

According to another aspect of the present disclosure, a wireless communications device comprises a transceiver, and a processor coupled with the transceiver, wherein the wireless communications device is configured to receive a first signal from a first next generation radio access network (NG-RAN) base station, the first signal including a fallback indication. The wireless communications device is further configured to, in response to receiving the first signal, transmit a second signal to a first evolved-universal mobile telecommunications system terrestrial radio access network (E-UTRAN) base station, the second signal including a connection request. The wireless communications device is further configured to transmit a third signal to a second wireless communications device, the third signal including a report in response to a connection failure with the first E-UTRAN base station.

According to another aspect of the present disclosure, a wireless communications device comprises a transceiver; and a processor coupled with the transceiver, wherein the wireless communications device is configured to: receive a first signal from a user equipment (UE), the first signal including a connection request. The wireless communications device is further configured to transmit a second signal to the UE, the second signal including an information request. The wireless communications device is further configured to receive a third signal from the UE, the third signal including a report generated in response to a failure to establish a connection between the UE and a second wireless communications device, the report comprising a fallback indication.

Other aspects, features, and embodiments will become apparent to those of ordinary skill in the art, upon reviewing the following description of specific, exemplary aspects in conjunction with the accompanying figures. While features may be discussed relative to certain aspects and figures below, all aspects can include one or more of the advantageous features discussed herein. In other words, while one or more aspects may be discussed as having certain advantageous features, one or more of such features may also be used in accordance with the various aspects discussed herein. In similar fashion, while exemplary aspects may be discussed below as device, system, or method aspects it should be understood that such exemplary aspects can be implemented in various devices, systems, and methods.

### BRIEF DESCRIPTION OF THE DRAWINGS

FIG. 1 illustrates a wireless communication network according to some aspects of the present disclosure.

FIG. 2 illustrates a communication scenario involving a UE, one or more BSs, and a control plane, according to some aspects of the present disclosure.

FIG. 3 is a block diagram of an exemplary UE according to some aspects of the present disclosure.

FIG. 4 is a block diagram of an exemplary BS according to some aspects of the present disclosure.

FIG. 5 is a graphical representation of a report according to aspects of the present disclosure.

FIG. 6 is a signaling diagram of communication between a UE, an NG-RAN BS, an E-UTRAN BS, and control plane elements, according to aspects of the present disclosure.

FIG. 7 is a signaling diagram of communication between a UE, an NG-RAN BS, an E-UTRAN BS, and an NG-RAN BS, according to aspects of the present disclosure.

FIG. 8 is a signaling diagram of communication between a UE, an NG-RAN BS, and an E-UTRAN BS, according to aspects of the present disclosure.

FIG. 9 is a flow diagram of a wireless communication method according to some aspects of the present disclosure.

FIG. 10 is a flow diagram of a wireless communication method according to some aspects of the present disclosure.

FIG. 11 is a diagram illustrating an example disaggregated BS architecture according to some aspects of the present disclosure.

FIG. 12 illustrates a diagram of a system including a device that supports RU sharing techniques in wireless communications according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

A 5G NR communication system may be implemented to use optimized OFDM-based waveforms with scalable numerology and transmission time interval (TTI). Additional features may also include having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented, or a method may be practiced using any number of the aspects set forth herein. In addition, such an apparatus may be implemented, or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

5G NR provides increased reliability and ubiquity of wireless data transmission. As 5G NR is rolled out, existing infrastructure configured for 3G, 4G, and LTE remains in place. In some instances, 5G NR wireless communications devices, such as base stations (BSs) may work in conjunction with wireless communications device or other components configured for 3G, 4G, and/or LTE. In some aspects, various functions of wireless communication may be allocated to 5G infrastructure while other functions are allocated to LTE infrastructure. As a result, a user equipment (UE), depending on its physical location and/or the designated function or procedure to be performed, must be able to communicate with both 5G infrastructure devices as well as LTE infrastructure devices and switch communicating between these devices quickly and efficiently. In some aspects, for example, when communication between a UE and an LTE BS is transferred to communication between the UE and a 5G BS, reports related to the transfer of communication may be generated and provided to either the original LTE BS or the new 5G BS to improve similar communication transfers in the future.

To better facilitate increased coverage of wireless data transmission, aspects of the present disclosure provide systems, devices, and methods, for providing feedback information to BSs involved in a fallback procedure in which communication to and from a 5G BS with a UE is transferred to an LTE BS. Specifically, a 5G BS and UE may disconnect. As part of disconnection, the 5G BS may provide the UE with a fallback indication related to which type of fallback occurred. The UE may store this information and then search for and identify an LTE BS. The UE then sends a connection request to the LTE BS. In the event that the connection with the LTE BS is not established, the UE may store information relating the failed connection attempt. The UE may then identify an alternative BS (such as an LTE BS or a 5G BS), and send a connection request to the alternative BS. After connection is established with the alternative BS, the alternative BS may request various reports from the UE. The UE may generate a report based on the stored information relating to the disconnection from the 5G BS as well as the failed connection. This information may include the fallback indication. The alternate BS may then transmit any of this information from the UE, including the fallback indication, to the 5G BS originally in communication with the UE. This information may be transmitted directly or via components of a core network. In some aspects, the 5G BS originally in communication with the UE may perform various optimizations based on the information received from the alternative BS. Such optimizations may include directing UEs involved in future fallbacks to different LTE BSs, specifying different types of BSs, or other optimizations. In that regard, aspects of the present disclosure advantageously provide feedback information to BSs involved in fallback procedures of various types quickly and efficiently, leading to improved communication quality.

In some cases, a UE which has disconnected from a BS may identify a new BS and send a connection request to the new BS. However, for various reasons, this connection request may fail and wireless communication may not be established between the UE and the new BS. The UE may then identify an alternative BS and send a connection request to the alternative BS. When, during a fallback procedure, a reconnection to the new BS fails, it may be desired to document information related to the connection failure and provide the BS to which the UE was originally connected with this information to improve fallback procedures in the future. However, current infrastructure does not support conveying this information to the BS in scenarios in which the originally connected BS is a 5G NR BS and the new BS selected for reconnection by the UE is an LTE BS. Therefore, there exists a need for improved methods of fallback procedures which allow the transmission of failed connectivity information to BSs involved in situations of LTE fallback from 5G NR.

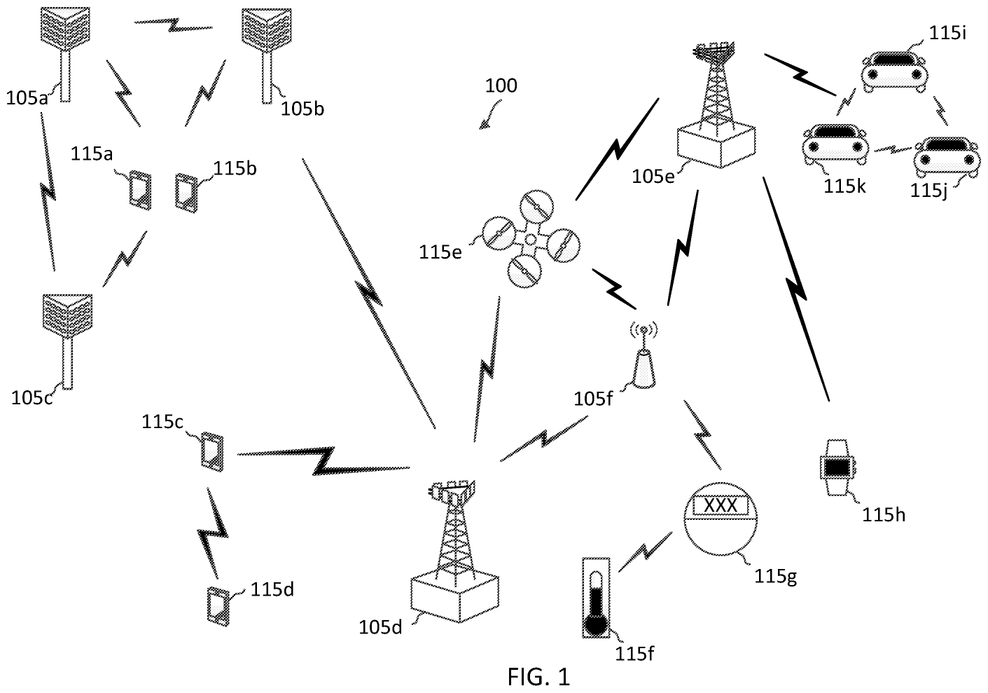

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cells. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communications device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communications devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115 (e.g., sidelink communications), and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRS s) and/or channel state information—reference signals (CSI-RS s) to enable a UE 115 to estimate a DL channel. Similarly, a UE 115 may transmit sounding reference signals (SRSs) to enable a BS 105 to estimate a UL channel. As further discussed with respect to the remaining figures below, sidelink UEs 115 may transmit sidelink reference signals between each other, such as for example modeled after CSI-RS, though other types are possible as well.

Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 may initiate an initial network attachment procedure with the network 100. When the UE 115 has no active data communication with the BS 105 after the network attachment, the UE 115 may return to an idle state (e.g., RRC idle mode). Alternatively, the UE 115 and the BS 105 can enter an operational state or active state, where operational data may be exchanged (e.g., RRC connected mode). For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the BS 105 may communicate with a UE 115 using HARQ techniques to improve communication reliability, for example, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft-combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the BS 105 may transmit a PRACH configuration to the UE 115. The PRACH configuration may indicate a set of ROs in the PRACH configuration. The BS 105 and/or the UE 115 may divide ROs into different groups, including a first group of ROs configured for PRACH repetitions, and a second group configured for single PRACH transmissions. In addition to BS-UE communication, as noted briefly above various UEs 115 may additionally, or alternatively, engage in sidelink communications with each other.

In some aspects, the BS 105 may be a 5G NR BS. The 5G NR BS and UE 115 may perform a fallback procedure in which communication is transferred from the 5G NR BS with the UE 115 to an LTE BS with the UE 115. Such a handover procedure may occur according to a voice fallback or emergency fallback, as well as based on load balancing or coverage needs. In some aspects, when a handover procedure is not successful, aspects of the present disclosure provide systems, devices, and methods for conveying information related to an unsuccessful handover to the LTE BS in a novel manner, so that the LTE BS may in turn convey information to the 5G NR BS which was originally in communication with the UE 115. In that regard, the 5G NR BS may alter various communication protocols, steps, or parameters to optimize future fallback procedures.

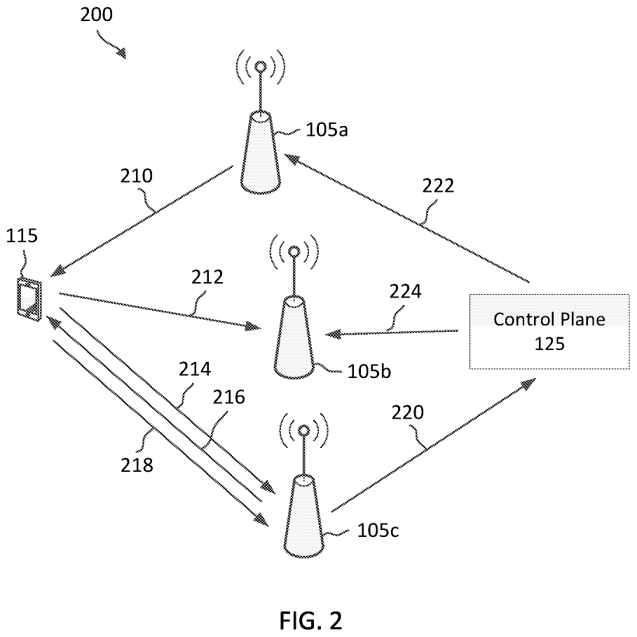

FIG. 2 illustrates a communication scenario involving a UE 115, one or more BSs 105, and a control plane 125, according to some aspects of the present disclosure. The scenario described with reference to FIG. 2 may relate to mobility robustness optimization (MRO) enhancements for inter-system handover voice fallback. In some aspects, handovers from a base station (BS) of one RAN type to another base station of a different RAN type may be optimized. The scenario shown and described with reference to FIG. 2 may correspond to a voice fallback scenario. For example, the UE 115 shown in FIG. 2 may be transmitting and/or receiving data wirelessly to facilitate a voice call. In some aspects, this voice call may include wireless communication with the BS 105 shown in FIG. 2 facilitating communication with another UE, or any other wireless communications device.

In some aspects, the UE 115 may have established wireless communication with the BS 105a shown. For example, the UE 115 may transmit and/or receive data relating to a voice call with another wireless communication device facilitated by the BS 105a.

The BS 105a may transmit a mobility command 210 to the UE 115. In some aspects, a mobility command may alternatively be referred to as a disconnect command or any other suitable term. In some aspects, the BS 105a may include a base station capable of facilitating wireless communication according to a 5^{th} generation new radio (5G) protocol. In this way, the BS 105a may be referred to as a next generation radio access technology network (NG-RAN) BS. The BS 105a may correspond to or be in communication with a 5G core network. In such a scenario, the BS 105a may be referred to as a stand-alone BS. In some aspects, the BS 105a may correspond to or be in communication with a 4^{th} generation (4G) or long-term evolution (LTE) core network. In such a scenario, the BS 105a may be referred to as a non-stand-alone BS.

The mobility command 210 may include any suitable command. For example, in an aspect in which the BS 105a is a stand-alone BS, the BS 105a may not be capable of supporting voice calls over NR. In such case, in response to a request by the UE 115 to establish a voice call, the BS 105a may transmit a mobility command 210 to the UE 115. In other examples, communication may be transferred from a 5G BS to a 4G BS for emergency services, or in response to load leveling or coverage issues. The mobility command 210 may initiate an inter-system fallback in which communication between the UE 115 and the NG-RAN BS 105a is terminated, and communication between the UE 115 and an E-UTRAN, such as the BS 105b or BS 105c is established.

In some aspects, an inter-system fallback may occur while the UE 115 is in a connected mode (e.g., RRC_CONNECTED) or while the UE 115 is in an idle mode (e.g., RRC_IDLE). In some aspects, an inter-system fallback procedure performed while the UE 115 is in a connected mode is referred to as a handover procedure or handover. In some aspects, an inter-system fallback procedure performed while the UE 115 is in an idle mode is referred to as a redirection procedure or redirection.

In some aspects, the mobility command 210 may include a mobility from NR command message. This command message may include a voice fallback indication. In some aspects, the voice fallback indication may instruct the UE 115 that a voice fallback procedure should be performed. In some aspects, the mobility from NR command message may alternatively include other fallback indications, including fallback indications relating to emergency services, load balancing, or coverage issues.

In some aspects, the mobility command 210 may include various data. For example, in addition to the fallback indication, the mobility command 210 may include a target radio access technology (RAT) type, such as a 4G BS, LTE BS, an evolved universal terrestrial radio access evolved packet core (E-UTRA/EPC), universal terrestrial radio access frequency division duplex (UTRA-FDD), or a RAT of any other type. In some aspects, the mobility command 210 may additionally include other data relating to the target RAT, such as a message container.

As shown in FIG. 2, in some aspects, the UE 115 may transmit a connection request 212, such as a RACH request, to a target BS. In some aspects, the specific target BS may be indicated by the BS 105a. In some aspects, only the type of target BS may be specified. In FIG. 2, the BS 105b may correspond to a BS specified by the BS 105a in the mobility command 210 or a type of BS specified by the BS 105a in the mobility command 210. In some cases, a connection request to a new target BS from the UE 115 may fail. For example, wireless communication may not be established between the UE 115 and the BS 105b. In some aspects, the communication between the UE 115 and the BS 105b may be terminated according to a voice fallback. As a result, the UE 115 may be configured to retry to establish wireless communication with the BS 105b by, for example, transmitting an additional connection request. In some aspects, in response to the connection request 212 being unsuccessful, the UE 115 may identify an additional target BS (e.g., a BS of the type specified by the mobility command 210) and transmit another connection request 214.

The connection request 214 may be similar to the connection request 212. In some aspects, the connection request 214 may include a RACH request.

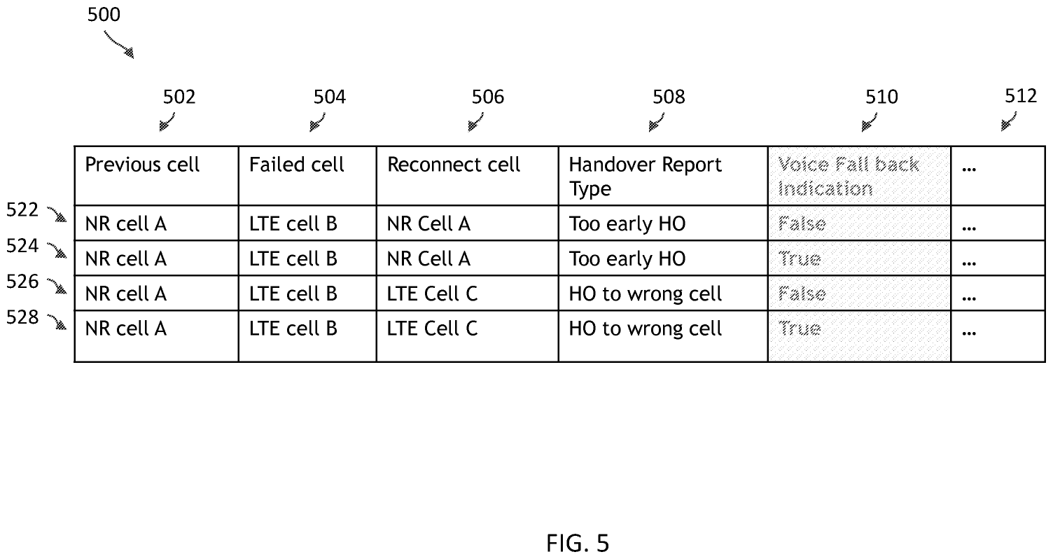

After wireless communication is established successfully between the UE 115 and the BS 105c, the BS 105c may transmit a request for information 216 to the UE 115. This request 216 may include a request for any suitable information. For example, the request for information 216 may include a request for information related to any previous failed connection attempts, or information related to the mobility command from prior BSs. In some aspects, the request for information 216 may include a request for the information relating to the failed connection request to the BS 105b stored in a memory of the UE 115. In some aspects, the request for information may include a request for information which was included in the disconnect command 210. The request for information 216 may include a request for any suitable report, such as any of the reports listed with reference to FIG. 5.

In response to the request for information 216, the UE 115 may transmit a report 218 to the BS 105c. In some aspects, the UE 115 may generate the report 218 by accessing information, including any of the information described above, from a memory of the UE 115. The report 218 may include a fallback indication. The fallback indication may indicate the type of fallback procedure which let to the disconnection from the BS 105a and the subsequent connection to the BS 105c. For example, the fallback indication may be a voice fallback indication if the fallback was due to a voice fallback. The fallback indication may also correspond to an emergency fallback, a fallback related to load balancing, a fallback related to coverage issues, for example, of the BS 105a, or any other type of fallback. A unique fallback indication may be included in the report 218 for each of these fallback types, as will be explained in more detail with reference to FIG. 5 hereafter. In that regard, the BS 105c may be configured to receive the report 218 including the unique fallback indication indicating the type of cross-RAT fallback may have been initiated by the BS 105a. In some aspects, the report 218 may be a cross-RAT configured to be received by an LTE BS.

After the BS 105c receives the report 218, the BS 105c may transmit a signal 220 including the report 218, or elements of the report 218 to a control plane 125. The control plane may include multiple components or aspects of a core network, such as an MME, AMF, SMF, UPF, IMS, SGW/PGW, or any other suitable components. In some examples, a portion of the control plane 125 may be dedicated to facilitating communication for LTE base stations and a portion of the control plane 125 may be dedicated to facilitating communication for 5G base stations. An additional portion of the control plane 125 may be dedicated to facilitating communication between LTE base stations and 5G base stations.

In the example shown in FIG. 2, the control plane 125 may forward the signal 220 to the BS 105a as signal 222. In some aspects, The BS 105a may perform various processing of the received signal 222 and may perform optimization based on the information in the signal 222. Aspects of the present disclosure advantageously enables fast and efficient transferal of information such as the fallback indication described with reference to the report 218 back to the BS 105a. Optimizations performed by the BS 105a may include selecting a different target BS to transfer the UE 115 to during a future handover or redirection procedure. Additional optimizations may include specifying a different type of target BS. Optimizations may also be performed depending on the type of fallback indication within the report, including whether the fallback indication related to voice, emergency, load balancing, or coverage issues.

In some aspects, the control plane 125 may additionally forward the signal 220 to the BS 105b as signal 224. In that regard, the BS 105b may additionally perform various optimization procedures to increase the quality or efficiency of communication and/or handover or redirection procedures involving the BS 105b.

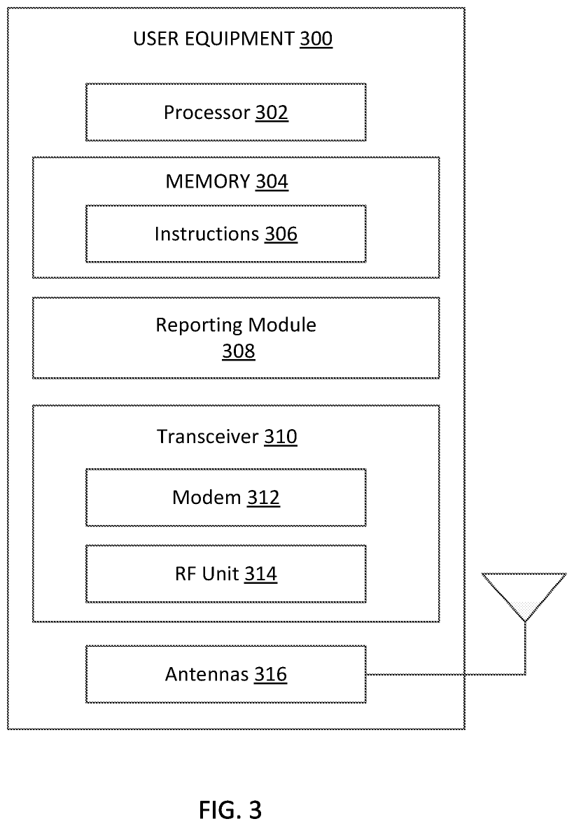

FIG. 3 is a block diagram of an exemplary UE 300 according to some aspects of the present disclosure. The UE 300 may be a UE 115 as discussed with reference to FIG. 1 and shown in multiple figures. As shown, the UE 300 may include a processor 302, a memory 304, a reporting module 308, a transceiver 310 including a modem subsystem 312 and a radio frequency (RF) unit 314, and one or more antennas 316. These elements may be coupled with one another. The term “coupled” may refer to directly or indirectly coupled or connected to one or more intervening elements. For instance, these elements may be in direct or indirect communication with each other, for example via one or more buses.

The processor 302 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 302 may also be implemented as a combination of computing devices, e.g., a combination of a DSP and a microprocessor, a plurality of microprocessors, one or more microprocessors in conjunction with a DSP core, or any other such configuration.

The memory 304 may include a cache memory (e.g., a cache memory of the processor 302), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 304 includes a non-transitory computer-readable medium. The memory 304 may store, or have recorded thereon, instructions 306. The instructions 306 may include instructions that, when executed by the processor 302, cause the processor 302 to perform the operations described herein with reference to a UE 115 or a BS 105 or other wireless communications device in connection with aspects of the present disclosure, for example, aspects of FIGS. 2 and 5-10. Instructions 306 may also be referred to as code, which may be interpreted broadly to include any type of computer-readable statement(s).

The reporting module 308 may be implemented via hardware, software, or combinations thereof. For example, the reporting module 308 may be implemented as a processor, circuit, and/or instructions 306 stored in the memory 304 and executed by the processor 302. In some aspects, the reporting module 308 can be integrated within the modem subsystem 312. For example, the reporting module 308 can be implemented by a combination of software components (e.g., executed by a DSP or a general processor) and hardware components (e.g., logic gates and circuitry) within the modem subsystem 312. The reporting module 308 may communicate with one or more components of the UE 300 to implement various aspects of the present disclosure, for example, aspects of FIGS. 2 and 5-10.

The reporting module 308 may be configured to perform various functions related to generating reports corresponding to fallback procedures between the UE 300 and one or more BSs (e.g., BS 400 described hereafter). Such functions may include identifying a target BS during a fallback procedure, such as an LTE BS to send a connection request to, determining whether connection is established with a target BS, storing information related to a mobility command or failed connection request, identifying an alternative target BS, generating a report based on the stored information, and transmitting the report. In some aspects, the reporting module 308 may additionally receive and/or process information requests or other signals from a BS. The reporting module 308 may generate a variety of reports. For example, the reporting module 308 may be configured to generate a radio link failure (RLF) report, a connection establishment failure (CEF) report, a cross-RAT report, a cross-RLF report, a cross-RAT CEF report, a RACH report, a successful handover report, a mobility history report, an SHR report, or any other suitable report.

As shown, the transceiver 310 may include the modem subsystem 312 and the RF unit 314. The transceiver 310 can be configured to communicate bi-directionally with other devices, such as the BSs 105. The modem subsystem 312 may be configured to modulate and/or encode the data from the memory 304 and/or the reporting module 308 according to a modulation and coding scheme (MCS), e.g., a low-density parity check (LDPC) coding scheme, a turbo coding scheme, a convolutional coding scheme, a digital beamforming scheme, etc. The RF unit 314 may be configured to process (e.g., perform analog to digital conversion or digital to analog conversion, etc.) modulated/encoded data (e.g., channel sensing reports, PUCCH UCI, PUSCH data, etc.) of transmissions originating from another source such as a UE 115, a BS 105, or an anchor. The RF unit 314 may be further configured to perform analog beamforming in conjunction with the digital beamforming. Although shown as integrated together in transceiver 310, the modem subsystem 312 and the RF unit 314 may be separate devices that are coupled together at the UE 300 to enable the UE 300 to communicate with other devices.

The RF unit 314 may provide the modulated and/or processed data, e.g., data packets (or, more generally, data messages that may contain one or more data packets and other information), to the antennas 316 for transmission to one or more other devices. The antennas 316 may further receive data messages transmitted from other devices. The antennas 316 may provide the received data messages for processing and/or demodulation at the transceiver 310. The transceiver 310 may provide the demodulated and decoded data (e.g., RRC table(s) for channel access configurations, scheduling grants, channel access configuration activation, timing advance configurations, RRC configurations, PUSCH configurations, SRS resource configurations, PUCCH configurations, BWP configurations, PDSCH data, PDCCH DCI, sidelink configurations, etc.) to the reporting module 308 for processing. The antennas 316 may include multiple antennas of similar or different designs in order to sustain multiple transmission links.

In an aspect, the UE 300 can include multiple transceivers 310 implementing different RATs (e.g., NR and LTE). In an aspect, the UE 300 can include a single transceiver 310 implementing multiple RATs (e.g., NR and LTE). In an aspect, the transceiver 310 can include various components, where different combinations of components can implement different RATs.

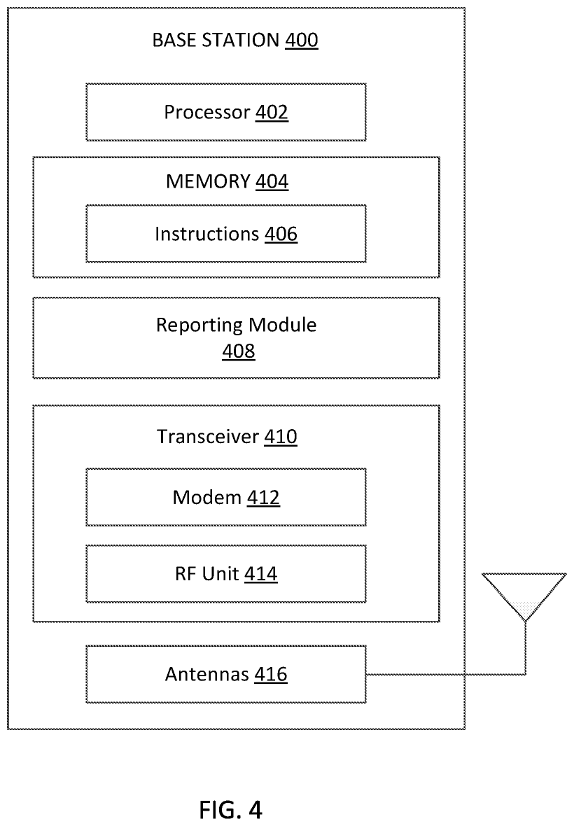

FIG. 4 is a block diagram of an exemplary BS 400 according to some aspects of the present disclosure. The BS 400 may be a BS 105 as discussed in FIG. 1. As shown, the BS 400 may include a processor 402, a memory 404, a reporting module 408, a transceiver 410 including a modem subsystem 312 and a RF unit 414, and one or more antennas 414. These elements may be coupled with one another. The term “coupled” may refer to directly or indirectly coupled or connected to one or more intervening elements. For instance, these elements may be in direct or indirect communication with each other, for example via one or more buses.

The processor 402 may have various features as a specific-type processor. For example, these may include a CPU, a DSP, an ASIC, a controller, an FPGA device, another hardware device, a firmware device, or any combination thereof configured to perform the operations described herein. The processor 402 may also be implemented as a combination of computing devices, e.g., a combination of a DSP and a microprocessor, a plurality of microprocessors, one or more microprocessors in conjunction with a DSP core, or any other such configuration.

The memory 404 may include a cache memory (e.g., a cache memory of the processor 402), RAM, MRAM, ROM, PROM, EPROM, EEPROM, flash memory, a solid-state memory device, one or more hard disk drives, memristor-based arrays, other forms of volatile and non-volatile memory, or a combination of different types of memory. In some aspects, the memory 404 may include a non-transitory computer-readable medium. The memory 404 may store instructions 406. The instructions 406 may include instructions that, when executed by the processor 402, cause the processor 402 to perform operations described herein, for example, aspects of FIGS. 2 and 5-10. Instructions 406 may also be referred to as program code. The program code may cause a wireless communications device to perform these operations, for example by causing one or more processors (such as processor 402) to control or command the wireless communications device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The reporting module 408 may be implemented via hardware, software, or combinations thereof. For example, the reporting module 408 may be implemented as a processor, circuit, and/or instructions 406 stored in the memory 404 and executed by the processor 402. In some examples, the reporting module 408 can be integrated within the modem subsystem 412. For example, the reporting 408 can be implemented by a combination of software components (e.g., executed by a DSP or a general processor) and hardware components (e.g., logic gates and circuitry) within the modem subsystem 412. The reporting 408 may communicate with one or more components of BS 400 to implement various aspects of the present disclosure, for example, aspects of FIGS. 2 and 5-10.

The reporting module 408 may be configured to perform various functions related generating and/or conveying information or data related to a fallback procedure for a UE in communication with the BS 400 (e.g., the UE 300 and/or the UE 115). Such functions may include generating and transmitting a mobility command to the UE. In some aspects, the reporting module 408 may additionally be configured to perform generating an information request for transmission to the UE. The information request may include a request for any suitable information. For example, requested information may include information related to any previous failed connection attempts, or information related to the mobility command from another BS. In some aspects, the request for information may include a request for the information relating to a failed connection request to another BS, or any other information. In some aspects, the reporting module 408 may additionally be configured to receive a report from the UE containing any of this information.

In some aspects, the reporting module 408 may additionally be configured to transmit a report to components of the core network or control plane (e.g., the control plane 125) in communication with the BS 400. In some aspects, the reporting module 408 may additionally be configured to perform various processing of the report, for example a report received from the UE, or a report generated by the reporting module 408.

In some aspects, the reporting module 408 may additionally receive a report from another BS or core network components. For example, the reporting module 408 (e.g., a reporting module of the BS 105a) may receive a report after a fallback procedure is completed. In some aspects, the reporting module 408 may analyze and/or process the report and determine various optimization functions to be performed by the BS 400 and/or commands for other components of the wireless communications system for optimization.

As shown, the transceiver 410 may include the modem subsystem 412 and the RF unit 414. The transceiver 410 can be configured to communicate bi-directionally with other devices, such as the UEs 115 and/or BS 400 and/or another core network element. The modem subsystem 412 may be configured to modulate and/or encode data according to a MCS, e.g., a LDPC coding scheme, a turbo coding scheme, a convolutional coding scheme, a digital beamforming scheme, etc. The RF unit 414 may be configured to process (e.g., perform analog to digital conversion or digital to analog conversion, etc.) modulated/encoded data (e.g., RRC table(s) for channel access configurations, scheduling grants, channel access configuration activation, RRC configurations, PDSCH data, PDCCH DCI, RACH Preamble Assignments, random access messages, sidelink resource pool configuration, sidelink reference signal parameter configuration, etc.) from the modem subsystem 412 (on outbound transmissions) or of transmissions originating from another source such as a UE 115. The RF unit 414 may be further configured to perform analog beamforming in conjunction with the digital beamforming. Although shown as integrated together in transceiver 410, the modem subsystem 412 and/or the RF unit 414 may be separate devices that are coupled together at the BS 400 to enable the BS 400 to communicate with other devices.

The RF unit 414 may provide the modulated and/or processed data, e.g., data packets (or, more generally, data messages that may contain one or more data packets and other information), to the antennas 414 for transmission to one or more other devices. The antennas 414 may further receive data messages transmitted from other devices and provide the received data messages for processing and/or demodulation at the transceiver 410. The transceiver 410 may provide the demodulated and decoded data (e.g., PRACH messages, channel sensing reports, PUCCH UCI, PUSCH data, etc.) to the reporting module 408 for processing. The antennas 414 may include multiple antennas of similar or different designs in order to sustain multiple transmission links.

In an aspect, the BS 400 can include multiple transceivers 410 implementing different RATs (e.g., NR and LTE). In an aspect, the BS 400 can include a single transceiver 410 implementing multiple RATs (e.g., NR and LTE). In an aspect, the transceiver 410 can include various components, where different combinations of components can implement different RATs. As will be described in more detail hereafter, the UE (e.g., the UE 115 and/or the UE 300) may transmit a report to a target BS during a fallback procedure (e.g., the BS 105c and/or the BS 400). The report may include various data relating to the handover or redirection of the UE, including specifying a previous BS, target BS, alternate BS, or any other wireless communications device as well as including fallback indications of various types.

FIG. 5 is a graphical representation of a report 500, according to aspects of the present disclosure. The report 500 may be any suitable type of report. As described in more detail hereafter, the report 500 may be a radio link failure (RLF) report, a connection establishment failure (CEF) report, a cross-RAT report, a cross-RLF report, a cross-RAT CEF report, a RACH report, a successful handover report, a mobility history report, or any other suitable report. In some aspects, the report 500 may be some aspects or fields of any of these reports. The report 500 may be transmitted between any suitable wireless communications devices. For example, the report 500 may be transmitted from [list all the different directions this thing can go]

The report 500 may include a field 502. The field 502 may correspond to a previous cell. For example, a previous cell may designate the BS which sent a mobility command to the UE. Referring to FIG. 2 described previously, the previous cell may correspond to the BS 105a.

The report 500 may also include a field 504. The field may correspond to a failed cell. For example, a failed cell may designate the BS to which the UE (e.g., UE 115) first sent a connection request, but which did not result in establishing communication. Referring to FIG. 2 described previously, the failed cell may correspond to the BS 105b.

The report 500 may also include a field 506. The field may correspond to a reconnect cell. For example, a reconnect cell may designate the BS to which the UE (e.g., UE 115) sent a connection request after attempting and failing to connect to the failed cell of field 504. In some aspects, the reconnect cell may be a BS with which the UE 115 successfully establishes a connection. Referring to FIG. 2 described previously, the reconnect cell may correspond to the BS 105c.

The report 500 may also include a field 508. The field 508 may specify the handover report type. In some aspects, the handover report type may indicate a reason for a handover report procedure. For example, the handover report type field may include possible values indicating that a handover was performed too early or too late, if the handover was performed with the wrong cell or BS. The handover report type field may also include values corresponding to an inter-system unnecessary handover, or an inter-system ping pong scenario. It is also noted that the field 508 may also specify a redirection report type, for example, in scenarios in which the UE is in an RRC idle or inactive mode.

The report 500 may also include a field 510. The field 510 may specify whether a voice fallback indication is included in the report. For example, if a voice fallback indication is included, it may indicate that a fallback procedure corresponding to the report was due to a voice fallback specifically.

In some aspects, the report 500 may be generated corresponding to an evolved packet system (EPS) fallback. In such case, the report 500 may include multiple fields to indicate the type of EPS fallback. For example, the field 510 may specify whether the EPS fallback corresponds to a voice fallback. However, additional fields may be included, as shown by the field 512, corresponding to indications for other fallback types. For example, an additional field may be provided corresponding to an emergency fallback indication which may be populated with a true or false value. Similarly, an additional field may be provided corresponding to a fallback indication corresponding to load balancing and an additional field may be provided corresponding to a fallback indication related to coverage issues. Additional fields may be provided for various additional fallback indication types.

FIG. 5 additionally depicts a number of values populating the fields 502-510. These example values may correspond to various communication scenarios. In one aspect, row 522 includes a set of exemplary values for each of the fields of the report 500. For example, the previous cell field 502 may be designated to NR cell A, indicating that the original cell was an NR BS. In some regards, the previous cell field 502, failed cell field 504, and/or reconnect cell field 506 may be populated with respective cell global identities (CGIs) of the corresponding BS for each field.

Continuing with the example of row 522, the failed cell field 504 may be designated as LTE cell B and the reconnect cell field 506 may be designated as NR Cell A. The handover report type field 508 may be designated as “Too early HO” indicating that the handover procedure was completed too early. The voice fallback indication is set to false indicating that the EPS fallback of row 522 was not a voice fallback.

In another aspect, row 524 includes an additional set of exemplary values. The previous cell field 502 is set to NR cell A, the failed cell field 504 may be designated as LTE cell B, and the reconnect cell field 506 may be designated as NR Cell A. Like row 522, the handover report type field 508 may be designated as “Too early HO.” The voice fallback indication is set to true indicating that the EPS fallback of row 522 was a voice fallback.

In another aspect, row 526 includes an additional set of exemplary values. The previous cell field 502 is set to NR cell A, the failed cell field 504 may be designated as LTE cell B, and the reconnect cell field 506 may be designated as LTE Cell C. The handover report type field 508 may be designated as “HO to wrong cell.” The voice fallback indication is set to false indicating that the EPS fallback of row 522 was not a voice fallback.

In another aspect, row 528 includes an additional set of exemplary values. The previous cell field 502 is set to NR cell A, the failed cell field 504 may be designated as LTE cell B, and the reconnect cell field 506 may be designated as LTE Cell C. The handover report type field 508 may be designated as “HO to wrong cell.” The voice fallback indication is set to true indicating that the EPS fallback of row 522 was a voice fallback.

It is to be understood that the fields 502-510, as well as any additional fields (e.g., as shown by the field 512) may include any suitable values or combination of values. Additional aspects of reports such as the report 500 will be described in more detail hereafter. The report 500 shown and described with reference to FIG. 5 may provide an example of information or data transmitted between wireless communications devices of the network disclosed. As will be explained hereafter, aspects of the report 500 may be transmitted from the UE to a target BS, an alternate BS, or any other BS, as described hereafter.

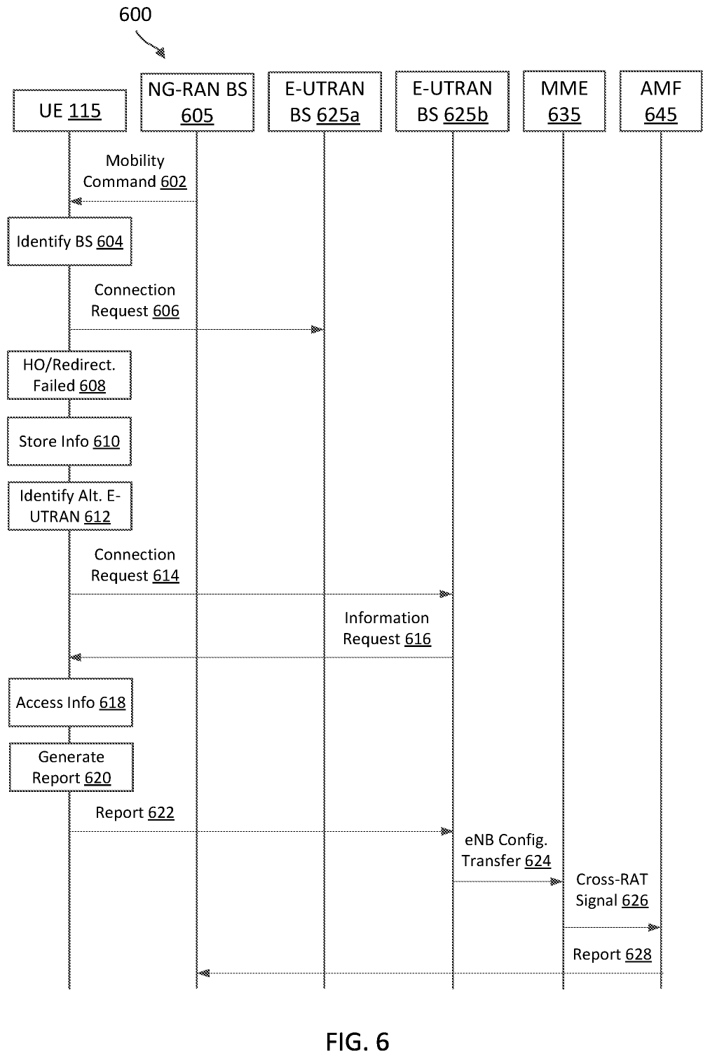

FIG. 6 is a signaling diagram 600 of communication between a UE 115, an NG-RAN BS 605, an E-UTRAN BS 625b, an MME 635, and an AMF 645, according to aspects of the present disclosure. The signaling diagram 600 may be implemented by any suitable wireless communications devices. In some aspects, the UE 115 may utilize one or more components, such as the processor 302, the memory 304, the reporting module 308, the transceiver 310, the modem 312, and one or more antennas 316 shown in FIG. 3 to perform any of the actions of the signaling diagram 600. In some aspects, the NG-RAN BS 605 may be similar to the BS 105 and/or the BS 400 described previously. For example, the NG-RAN BS 605 may utilize one or more components, such as the processor 402, the memory 404, the reporting module 408, the transceiver 410, the modem 412, and the one or more antennas 414 shown in FIG. 4. In some aspects, the E-UTRAN BS 625a and/or the E-UTRAN BS 625b may be similar to the BS 105 and/or the BS 400 described previously. For example, the E-UTRAN BS 625a and/or the E-UTRAN BS 625b may utilize one or more components, such as the processor 402, the memory 404, the reporting module 408, the transceiver 410, the modem 412, and the one or more antennas 414 shown in FIG. 4. As illustrated, the signaling diagram 600 includes a number of enumerated actions, but aspects of FIG. 6 may include additional actions before, after, and between the enumerated actions. In some aspects, one or more of the enumerated actions may be omitted, combined together, or performed in a different order.

Aspects of the signaling diagram 600 may describe an inter-system fallback procedure. As previously mentioned with reference to FIG. 2, an inter-system fallback may occur while the UE 115 is in a connected mode (e.g., RRC_CONNECTED) or while the UE 115 is in an idle or inactive mode (e.g., RRC_IDLE). In some aspects, an inter-system fallback procedure performed while the UE 115 is in a connected mode is referred to as a handover procedure or handover. In some aspects, an inter-system fallback procedure performed while the UE 115 is in an idle mode is referred to as a redirection procedure or redirection. Aspects of the signaling diagram 600 will first be described with reference to a handover procedure and thereafter described with reference to a redirection procedure.

At action 602, the NG-RAN BS 605 may transmit a mobility command to the UE 115. The NG-RAN BS 605 may be a 5G base station, including a stand-alone or non-stand-alone BS. The mobility command described with reference to action 602 may be substantially similar to the mobility command 210 described with reference to FIG. 2. The mobility command of action 602 may initiate an inter-system fallback in which communication between the UE 115 and the NG-RAN BS 605 is terminated, and communication between the UE 115 and an E-UTRAN is established.

In some aspects, the mobility command of action 602 may include a mobility from NR command message. This command message may include a voice fallback indication. In some aspects, the voice fallback indication may instruct the UE 115 that a voice fallback procedure should be performed. In some aspects, the mobility from NR command message may alternatively include other fallback indications, including fallback indications relating to emergency services, load balancing, or coverage issues. In some aspects, while aspects of the disclosure apply to fallback indications of any type as disclosed herein, discussion in the following is focused primarily on voice fallback procedures in particular, though any aspects or principles described with reference to a voice fallback procedure may apply equally to fallback procedures of any type.

In some aspects, the mobility command may include various data. For example, in addition to the fallback indication, the mobility command may include a target RAT type, such as a 4G BS, LTE BS, E-UTRA/EPC, UTRA-FDD, or a RAT of any other type. In some aspects, the mobility command may additionally include other data relating to the target RAT, such as a message container.

At action 604, the UE 115 may identify a target BS. In some aspects, action 604 may additionally include storing the information from the mobility command 602 in a memory of the UE 115. For example, at action 604, the UE 115 may store the fallback indication included in the mobility command 602 specifying whether the fallback relates to a voice fallback, an emergency fallback, or a fallback related to load balancing or coverage. In some aspects, UE 115 may store data such as an indication of a target RAT, a type of target RAT, or a message or message container related to the target RAT. In some aspects, the information from the mobility command may be stored in a variable.

In some aspects, the UE 115 may identify a target RAT in any suitable way. For example, the UE 115 may identify a target RAT at action 604 based on a RAT specified by the BS 605 within the mobility command 602. In some aspects, the UE 115 may select a target RAT based on a type of RAT specified by the BS 605 within the mobility command 602.

At action 606, the UE 115 transmits a connection request to the E-UTRAN BS 625a. In some aspects, the connection request may include a RACH request.

At action 608, the UE 115 may determine that the connection between the UE 115 and the E-UTRAN BS 625a was unsuccessful. The UE 115 may be configured to make this determination in any way. For example, the UE 115 may determine that the connection to the E-UTRAN BS 625a failed in response to not receiving a response signal from the E-UTRAN BS 625a.

At action 610, the UE 115 may store information related to the failure to establish a connection with the E-UTRAN BS 625a. This information may include any suitable data, including, for example, metrics related to a channel quality between the UE 115 and the E-UTRAN BS 625a, biographical information relating to the connection request, such as a time of the request, contents of the request, or other specified parameters of the request, or any other information. In some aspects, the information stored by the UE 115 at action 610 may include any of the information included in the mobility command of action 602 described previously or the mobility command 210 of FIG. 2.

In some aspects, the information relating to the failed connection may be stored in a variable (e.g., VarRLF-Report). In that regard, the UE 115 may access a VarRLF report corresponding to the NG-RAN BS 625a for information to include in a response to the request for information from the E-UTRAN BS 625c. Any information within the VarRLF report may be selected and included within the report generated at action 612 described hereafter.

At action 612, the UE 115 may identify an alternate target E-UTRAN BS. For example, the UE 115 may identify the E-UTRAN BS 625b as an alternate target E-UTRAN BS. As described with reference to action 604, this may be accomplished in any suitable way, including based on a RAT specified by the BS 605 within the mobility command 602, such as an alternate RAT or based on a type of RAT specified by the BS 605 within the mobility command 602.

At action 614, the UE 115 may transmit a connection request to the alternate target RAT identified at action 612. As described with reference to action 606, the connection request may include a RACH request or any other request.

At action 616, the E-UTRAN BS 625b may transmit a request for information to the UE 115. In some aspects, the E-UTRAN BS 625b may transmit the request for information to the UE 115 in response to a connection being established between the UE 115 and the E-UTRAN BS 625b. The request for information may specify any suitable information. For example, the request for information may include a request for information related to any previous failed connection attempts, or information related to the mobility command from prior BSs. In some aspects, the request for information at action 616 may include a request for the information relating to the failed connection request to the E-UTRAN BS 625a stored at action 610. In some aspects, the request for information may include request for information from the mobility command 602. In other aspects, the request for information may include a request for information related to or resulting from any of actions 602-614.

At action 618, the UE 115 may access the information requested. In some aspects, the UE 115 may access the memory of the UE 115 and retrieve the requested information.

At action 620, the UE 115 generates a report. In some aspects, the report may be based on, or include, any of the information requested by the E-UTRAN BS 625b, including any of the information described with reference to action 616. In some aspects, the report generated at action 620 may include a radio link failure (RLF) report. The RLF report may include any suitable data. In some aspects, the RLF report may include any of the data or types of data shown and described with reference to FIG. 5. Notably, the RLF report may include the fallback indication. Referring to FIG. 5, the fallback indication may correspond to a voice fallback indication. In some aspects, the RLF report may additionally or alternatively include fallback indications of different types, such as an emergency fallback indication, a fallback indication due to load balancing, a fallback indication due to coverage issues, or any other type of fallback indication. In some aspects, the report generated by the UE 115 at action 620 may be referred to as a cross-RAT report or a cross-RAT RLF report. In that regard, the report generated at action 620 may be report intended for an LTE BS, such as the E-UTRAN BS 625b containing information relating to a handover from a 5G BS (e.g., the NG-RAN BS 605) to an LTE BS (E-UTRAN BS 625b).

In some aspects, the report generated at action 620 may include an indication of the NG-RAN BS 605. The report may be stored and/or transmitted (e.g., with reference to action 622) as an octet string or 8-bit byte. In some aspects, a field of the report may indicate the primary cell (PCell) in which an RLF was detected and/or the source PCell of a failed handover. The report may include a field in which a measurement result is included and set to a value of an RLF report. In some aspects, the report may include a time that has elapsed since the last radio link failure or handover failure associated with the NG-RAN BS 605, the E-UTRAN BS 625a, and/or the E-UTRAN BS 625b.

In some aspects, the report generated at action 620 may also include information related to interruption time. For example, the report may include a handover interruption time. In that regard, the report may include a metric corresponding to the time between reception of a mobility from NR command to a successful RACH on the target E-UTRA cell (e.g., the E-UTRAN BS 625b).

At action 622, the report generated at action 620 may be transmitted to the E-UTRAN BS 625b. This report may be transmitted in any suitable way or according to any wireless communication scheme or schedule. In some aspects, the E-UTRAN BS 625b may be configured to transmit an indication to the UE 115 that the report was successfully received in response to receiving the report at action 622. In that regard, the UE 115 may be configured to receive the indication. The UE 115 may then discard or otherwise delete the report from the memory of the UE 115 in response to receiving this indication that the report was successfully received by the E-UTRAN BS 625b. In some aspects, the UE 115 may determine that report was successfully received in any other way. In some aspects, it may be determined that the report was successfully transmitted and received as confirmed by lower layers.

At action 624, the E-UTRAN BS 625b may transmit an eNB configuration to the mobile management entity (MME) 635. The MME 635 as well as the access and mobility management function (AMF) 645 may be components of a network core. In some aspects, the MME 635 and 645 may be a part of a control plane, such as the control plane 125 shown and described with reference to FIG. 2. In some aspects, the MME 635 and/or the AMF 645 may be in wireless or physical communication with any of the BS s disclosed herein. For example, as shown in FIG. 6, the E-UTRAN BS 625b may transmit the eNB configuration to the MME 635 via a wireless or wired connection. Similarly, the MME 635 may be in wireless or wired connection with any of the NG-RAN 605, the E-UTRAN BS 625a, or any other BS. Information may be transferred to and/or from any of the NG-RAN 605, the E-UTRAN BS 625a, and/or the E-UTRAN BS 625b via an S1 interface. The eNB configuration may include any of the information of the report described with reference to actions 620-622.

At action 626, the MME 635 may transmit across-RAT signal to the AMF 645. In some aspects, the cross-RAT signal may be an N26 message. In some aspects, the cross-RAT signal may be transmitted via an N26 interface. The N26 interface may facilitate communication between wireless communications device of different communication protocols. For example, an N26 message may facilitate communication between a 5G wireless communications device (e.g., the NG-RAN BS 605) and an LTE wireless communications device (e.g., the E-UTRAN BS 625b). In that regard, the cross-RAT signal of action 626 may include any of the information included in the report described with reference to actions 620-622.

At action 628, a report may be generated and transmitted from the AMF 645 to the NG-RAN BS 605. In some aspects, the report of action 628 may the same report described with reference to actions 620-622. In some aspects, the report may be a separate report generated by the AMF 645 but may include any or all of the information of the report described with reference to actions 620-622.

As previously mentioned, aspects of the signaling diagram 600 of FIG. 6 will now be described with reference to a redirection procedure.

At action 602, the NG-RAN BS 605 may transmit a mobility command to the UE 115. The mobility command of action 602 may also initiate an inter-system fallback in which communication between the UE 115 and the NG-RAN BS 605 is terminated, and communication between the UE 115 and an E-UTRAN is established. For a redirection procedure, the mobility command of action 602 may be an RRC release message. In some aspects, a UE 115 may be in an RRC connected mode and may transition to an RRC idle mode in response to receive the RRC release message at action 602. The RRC release message may include any of the data or information described above with reference to action 602 of a handover procedure. For example, the RRC release message may include a fallback indication of any type described previously. In some aspects, the RRC release message of action 602 may be transmitted to the UE 115 instructing the UE 115 to transition to an RRC idle mode due to a voice fallback.

At action 604, the UE 115 may identify a target BS. Action 604 may include substantially similar steps with regards to a redirection procedure. For example, the UE 115 may search for and identify a target BS. The target BS may be an LTE BS as opposed to a target NR BS. For example, an LTE BS may facilitate voice communication for the UE 115.

At action 606, the UE 115 transmits a connection request to the E-UTRAN BS 625a. In some aspects, the connection request may include a RACH request. With regards to a redirection procedure, the connection request to the E-UTRAN BS 625a may be substantially similar and may be referred to as a redirection.

At action 608, the UE 115 may determine that the connection between the UE 115 and the E-UTRAN BS 625a was unsuccessful. With reference to a redirection procedure, action 608 may be substantially similar to the handover procedure described previously.

At action 610, the UE 115 may store information related to the failure to establish a connection with the E-UTRAN BS 625a. With reference to a redirection procedure, the action 610 may be similar to the handover procedure previously described. In some aspects, the data stored at action 610 of a redirection procedure may be stored in a different variable, such as a variable or field of a connection establishment failure (CEF) report.

At action 612, the UE 115 may identify an alternate target E-UTRAN BS. With reference to a redirection procedure, action 612 may be substantially similar to the handover procedure previously described.

At action 614, the UE 115 may transmit a connection request to the alternate target RAT identified at action 612. With regards to a redirection procedure, the connection request to the E-UTRAN BS 625b may be substantially similar to the handover procedure.

At action 616, the E-UTRAN BS 625b may transmit a request for information to the UE 115. With reference to a redirection procedure, action 616 may be substantially similar to the handover procedure previously described.

At action 618, the UE 115 may access the information requested. With reference to a redirection procedure, action 618 may be substantially similar to the handover procedure previously described.

At action 620, the UE 115 generates a report. With reference to a redirection procedure, action 620 may be similar. For a redirection procedure, the report generated at action 620 may be referred to as a CEF report. The CEF report may include any of the data or information described above with reference to the report of action 620. In addition, the CEF report may include an indicator that redirection failed due to a fallback. The CEF report may also include an indicator specifying the type of fallback which triggered the redirection (e.g., voice, emergency, load balancing, coverage issues, etc.). In some aspects, the CEF report may include a cell global identity (CGI) of the NG-RAN BS 605. The CEF report may also include a cause of redirection failure with regards to action 606. In some aspects, the report may include a metric corresponding to the time between an RRC release and successful RACH on the target E-UTRA cell (e.g., the E-UTRAN BS 625b) if the RRC Release was triggered for the purpose of redirection to the E-UTRA cell due to voice fallback indication.

At action 622, the report generated at action 620 may be transmitted to the E-UTRAN BS 625b. With reference to a redirection procedure, action 620 may be similar. The action 620 may be transmitted to the E-UTRAN BS 625b at any suitable time. For example, the report may be transmitted to the E-UTRAN BS 625b upon the expiration of various timers. For example, the report may be transmitted to the E-UTRAN BS 625b at the expiration of any of the timers T300, T319, or T320.

At action 624, the E-UTRAN BS 625b may transmit an eNB configuration to the mobile management entity (MME) 635. With reference to a redirection procedure, action 624 may be substantially similar to the handover procedure previously described.

At action 626, the MME 635 may transmit an N26 message to the AMF 645. With reference to a redirection procedure, action 626 may be substantially similar to the handover procedure previously described.

At action 628, a report may be generated and transmitted from the AMF 645 to the NG-RAN BS 605. With reference to a redirection procedure, action 628 may be substantially similar to the handover procedure previously described.

The NG-RAN BS 605 may perform various processing of the report received at action 628 and may perform optimization based on the information in the report. Aspects of the present disclosure advantageously enables fast and efficient transferal of information included in the report described with reference to actions 620-622 back to the NT-RAN BS 605. Optimizations performed by the NG-RAN BS 605 based on the information in the report received at action 628 may include selecting a different target E-UTRAN BS to indicate in a subsequent mobility command with increased likelihood of successful connection. Additional optimizations may include specifying a different type of target BS. Optimizations may also be performed depending on the type of fallback indication within the report, including whether the fallback indication related to voice, emergency, load balancing, or coverage issues. With reference to a redirection procedure, action 628 may be substantially similar.

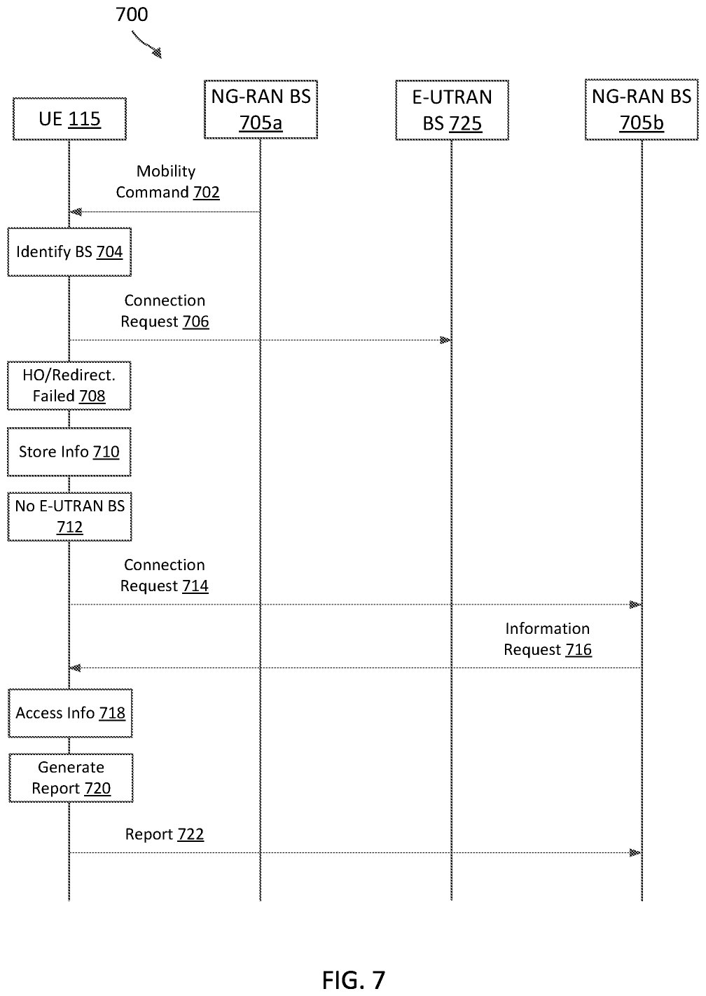

FIG. 7 is a signaling diagram 700 of communication between a UE 115, an NG-RAN BS 705a, an E-UTRAN BS 725, and an NG-RAN 705b, according to aspects of the present disclosure. According to aspects of the present disclosure, the signaling diagram 700 may illustrate a communication scenario in which a connection request to a target BS (e.g., E-UTRAN BS 725) fails, no suitable alternate BS is identified, and the UE initiates communication with an NG-RAN BS instead.

The signaling diagram 700 may be implemented by any suitable wireless communications devices. In some aspects, the UE 115 may utilize one or more components, such as the processor 302, the memory 304, the reporting module 308, the transceiver 310, the modem 312, and one or more antennas 316 shown in FIG. 3 to perform any of the actions of the signaling diagram 700. In some aspects, the NG-RAN BS 605 may be similar to the BS 105 and/or the BS 400 described previously. For example, the NG-RAN BS 705a and/or NG-RAN BS 705b may utilize one or more components, such as the processor 402, the memory 404, the reporting module 408, the transceiver 410, the modem 412, and the one or more antennas 414 shown in FIG. 4. In some aspects, the E-UTRAN BS 725 may be similar to the BS 105 and/or the BS 400 described previously. For example, E-UTRAN BS 725 may utilize one or more components, such as the processor 402, the memory 404, the reporting module 408, the transceiver 410, the modem 412, and the one or more antennas 414 shown in FIG. 4. As illustrated, the signaling diagram 700 includes a number of enumerated actions, but aspects of FIG. 7 may include additional actions before, after, and between the enumerated actions. In some aspects, one or more of the enumerated actions may be omitted, combined together, or performed in a different order.

It is noted that any of the actions 702-722 of the signaling diagram 700 may be performed with respect to a UE (e.g., UE 115) in a connected or idle mode. In that regard, the signaling diagram 700 may correspond to a handover procedure or a redirection procedure. Aspects of the signaling diagram 700 will first be described with reference to a handover procedure and thereafter described with reference to a redirection procedure.

In some aspects, the signaling diagram 600 shown in FIG. 6 may correspond to a dual-connectivity scenario. For example, the NG-RAN BS 605 may be a master node and the E-UTRAN BS 625b may be a secondary node. In that regard, the E-UTRAN BS 625b may be in communication with the NG-RAN BS 605 and/or the E-UTRAN BS 625a. In some aspects, the signaling diagram 600 may correspond to a scenario in which the master node is an NR cell and the secondary node is an LTE cell (NE-DC). In other aspects, the signaling diagram 600 may correspond to a scenario in which the master node is an LTE cell and the secondary node is an NR cell (EN-DC). As will be described with reference to FIG. 7, in other aspects, a dual-connectivity communication scenario may include the UE 115 in communication with two NR cells.

In a dual-connectivity scenario, the UE 115 may be in communication with both the NG-RAN BS 605 as a master node and the E-UTRAN BS 625b as a secondary node simultaneously. In such a scenario, the E-UTRAN BS 625b may not need to send an information request (e.g., at action 616). Rather, the UE 115 may be configured to automatically generate the report (e.g., at action 620) and transmit the report to the E-UTRAN BS 625b (e.g., at action 622). In such a scenario processing time and computational resources may be preserved. In this scenario, the report generated at action 620 may be referred to as or include master cell group (MCG) failure information and may include any of the types of fallback information described herein. The E-UTRAN BS 625b may then transmit the report, including MCG failure information and/or the fallback indication to the NG-RAN 605. The NG-RAN 605 may then perform any of the optimization procedures described herein to improve communication quality and efficiency. In some aspects, an optimization procedure performed by the NG-RAN 605 may include selecting a different secondary node. In an aspect in which a different secondary node is selected, any of the reports described herein may include an indication of whether the secondary node was changed. Any of these reports may also include an indication of the prior secondary node cell ID (e.g., CGI) or the new secondary node cell ID.

At action 702, the NG-RAN BS 705a may transmit a mobility command to the UE 115. The action 702 may be similar to the action 602 described previously. The NG-RAN BS 705a may be a 5G base station, including a stand-alone or non-stand-alone BS. The mobility command of action 702 may initiate an inter-system fallback in which communication between the UE 115 and the NG-RAN BS 705a is terminated, and the UE 115 attempts to establish communication between the UE 115 and the E-UTRAN BS 725.

In some aspects, the mobility command of action 702 may include a mobility from NR command message and may include various fallback indications, including fallback indications relating to voice, emergency services, load balancing, or coverage issues. In some aspects, the mobility command may include various data including a target RAT type and/or other data relating to the target RAT, such as a message container.

At action 704, the UE 115 may identify a target BS. The action 704 may be similar to the action 604 described previously. In some aspects, action 704 may include storing the information from the mobility command 702. For example, at action 704, the UE 115 may store the fallback indication included in the mobility command 702 specifying whether the fallback relates to a voice fallback, an emergency fallback, or a fallback related to load balancing or coverage. In some aspects, UE 115 may store an indication of a target RAT, a type of target RAT, or a message or message container related to the target RAT. In some aspects, the information from the mobility command may be stored in a variable.

In some aspects, the UE 115 may identify a target RAT in any suitable way. For example, the UE 115 may identify a target RAT at action 704 based on a RAT specified by the NG-RAN BS 705a within the mobility command 702. In some aspects, the UE 115 may select a target RAT based on a type of RAT specified by the NG-RAN BS 705a within the mobility command 702.

At action 706, the UE 115 transmits a connection request to the E-UTRAN BS 725. In some aspects, the connection request may include a RACH request. The action 706 may be similar to the action 606 described previously.

At action 708, the UE 115 may determine that the connection between the UE 115 and the E-UTRAN BS 725 was unsuccessful. The action 708 may be similar to the action 608 described previously. The UE 115 may be configured to make this determination in any way. For example, the UE 115 may determine that the connection to the E-UTRAN BS 725 failed in response to not receiving a response signal from the E-UTRAN BS 725.

At action 710, the UE 115 may store information related to the failure to establish a connection with the E-UTRAN BS 725. The action 710 may be similar to the action 610 described previously. This information may include any suitable data, including, for example, metrics related to a channel quality between the UE 115 and the E-UTRAN BS 725, biographical information relating to the connection request, such as a time of the request, contents of the request, or other specified parameters of the request, or any other information. In some aspects, the information stored by the UE 115 at action 710 may include any of the information included in the mobility command of action 702. In some aspects, the information relating to the failed connection may be stored in a variable (e.g., VarRLF-Report).

At action 712, the UE 115 may search for an alternate E-UTRAN BS. For example, the UE 115 may search for an alternate E-UTRAN BS because the connection request described with reference to action 706 was unsuccessful. In the example shown in FIG. 7, the UE 115 may not identify an alternate E-UTRAN BS. This failure to find a suitable alternative E-UTRAN BS may be due to coverage issues, or any other suitable circumstances.

At action 714, the UE 115 may search for an NG-RAN BS rather than an alternate E-UTRAN BS in response to failing to identify an alternate E-UTRAN BS at action 712. In some aspects, the NG-RAN BS identified may be the NG-RAN BS 705b shown in FIG. 7. In some aspects, the NG-RAN BS identified may be the NG-RAN BS 705a which originally had established communication with the UE 115 (e.g., as shown by action 702). In that regard, the UE 115 may transmit a connection request to the NG-RAN BS identified at action 714. The connection request may include a RACH request or any other request.

At action 716, the NG-RAN BS 705b may transmit a request for information to the UE 115. The action 716 may be similar to the action 616 described previously. In some aspects, the NG-RAN BS 705b may transmit the request for information to the UE 115 in response to a connection being established between the UE 115 and the NG-RAN BS 705b. The request for information may specify any suitable information. For example, the request for information may include a request for information related to any previous failed connection attempts, or information related to the mobility command from prior BSs. In some aspects, the request for information at action 716 may include a request for the information relating to the failed connection request to the NG-RAN BS 705b stored at action 710. In some aspects, the request for information may include request for information from the mobility command 702. In other aspects, the request for information may include a request for information related to or resulting from any of actions 702-714.

At action 718, the UE 115 may access the information requested. The action 718 may be similar to the action 618 described previously. In some aspects, the UE 115 may access the memory of the UE 115 and retrieve the requested information.

At action 720, the UE 115 generates a report. The action 720 may be similar to the action 620 described previously. In some aspects, the report may be based on, or include, any of the information requested by the NG-RAN BS 705b, including any of the information described with reference to action 716. In some aspects, the report generated at action 720 may include a radio link failure (RLF) report. The RLF report may include any suitable data. In some aspects, the RLF report may include any of the data or types of data shown and described with reference to FIG. 5. Notably, the RLF report may include the fallback indication. Referring to FIG. 5, the fallback indication may correspond to a voice fallback indication. In some aspects, the RLF report may additionally or alternatively include fallback indications of different types, such as an emergency fallback indication, a fallback indication due to load balancing, a fallback indication due to coverage issues, or any other type of fallback indication. In some aspects, the report generated by the UE 115 at action 720 may be referred to as a cross-RAT report or a cross-RAT RLF report.

In some aspects, the report generated at action 720 may include an indication of the NG-RAN BS 705a. The report may be stored and/or transmitted (e.g., with reference to action 722) as an octet string or 8-bit byte. In some aspects, a field of the report may indicate the primary cell (PCell) in which an RLF was detected and/or the source PCell of a failed handover. The report may include a field in which a measurement result is included and set to a value of an RLF report. In some aspects, the report may include a time that has elapsed since the last radio link failure or handover failure associated with the NG-RAN BS 705a, the E-UTRAN BS 725, and/or the NG-RAN BS 705b.

In some aspects, the report generated at action 720 may also include information related to interruption time. For example, the report may include a handover interruption time. In that regard, the report may include a metric corresponding to the time between reception of a mobility from NR command to a successful RACH on the target cell (e.g., the NG-RAN 705b).

At action 722, the report generated at action 720 may be transmitted to the NG-RAN BS 705b. The action 722 may be similar to the action 622 described previously. This report may be transmitted in any suitable way or according to any wireless communication scheme or schedule. In some aspects, the NG-RAN 705b may be configured to transmit an indication to the UE 115 that the report was successfully received in response to receiving the report at action 722. In that regard, the UE 115 may be configured to receive the indication. The UE 115 may then discard or otherwise delete the report from the memory of the UE 115 in response to receiving this indication that the report was successfully received by the NG-RAN 705b. In some aspects, the UE 115 may determine that report was successfully received in any other way. In some aspects, it may be determined that the report was successfully transmitted and received as confirmed by lower layers.

As previously mentioned, aspects of the signaling diagram 700 of FIG. 7 will now be described with reference to a redirection procedure.

At action 702, the NG-RAN BS 705a may transmit a mobility command to the UE 115. The action 702 may be similar to the action 602 described previously. For a redirection procedure, the mobility command of action 702 may be an RRC release message. In some aspects, a UE 115 may be in an RRC connected mode and may transition to an RRC idle mode in response to receive the RRC release message at action 702.

At action 704, the UE 115 may identify a target BS. The action 704 may be similar to the action 604 described previously. Action 704 may include substantially similar steps with regards to a redirection procedure as the handover procedure previously described.

At action 706, the UE 115 transmits a connection request to the E-UTRAN BS 725. In some aspects, the connection request may include a RACH request. The action 706 may be similar to the action 606 described previously. Action 706 may include substantially similar steps with regards to a redirection procedure as the handover procedure previously described.

At action 708, the UE 115 may determine that the connection between the UE 115 and the E-UTRAN BS 725 was unsuccessful. The action 708 may be similar to the action 608 described previously. Action 708 may include substantially similar steps with regards to a redirection procedure as the handover procedure previously described.

At action 710, the UE 115 may store information related to the failure to establish a connection with the E-UTRAN BS 725. The action 710 may be similar to the action 610 described previously. Action 710 may include substantially similar steps with regards to a redirection procedure as the handover procedure previously described.

At action 712, the UE 115 may search for an alternate E-UTRAN BS. Action 712 may include substantially similar steps with regards to a redirection procedure as the handover procedure previously described.

At action 714, the UE 115 may search for an NG-RAN BS rather than an alternate E-UTRAN BS in response to failing to identify an alternate E-UTRAN BS at action 712. Action 714 may include substantially similar steps with regards to a redirection procedure as the handover procedure previously described.

At action 716, the NG-RAN BS 705b may transmit a request for information to the UE 115. The action 716 may be similar to the action 616 described previously. Action 716 may include substantially similar steps with regards to a redirection procedure as the handover procedure previously described.

At action 718, the UE 115 may access the information requested. The action 718 may be similar to the action 618 described previously. Action 718 may include substantially similar steps with regards to a redirection procedure as the handover procedure previously described.

At action 720, the UE 115 generates a report. The action 720 may be similar to the action 620 described previously. The action 720 may be similar to the action 620 described previously. For a redirection procedure, the report generated at action 720 may be referred to as a CEF report. The CEF report may include any of the data or information described above with reference to the report of action 720. In addition, the CEF report may include an indicator that redirection failed due to a fallback. The CEF report may also include an indicator specifying the type of fallback which triggered the redirection (e.g., voice, emergency, load balancing, coverage issues, etc.). In some aspects, the CEF report may include a cell global identity (CGI) of the NG-RAN BS 705a. The CEF report may also include a cause of redirection failure with regards to action 706. In some aspects, the report may include a metric corresponding to the time between an RRC release and successful RACH on the target cell (e.g., the NG-RAN BS 705a) if the RRC Release was triggered for the purpose of redirection to the cell due to voice fallback indication.

At action 722, the report generated at action 720 may be transmitted to the NG-RAN BS 705b. The action 722 may be similar to the action 622 described previously. Action 722 may include substantially similar steps with regards to a redirection procedure as the handover procedure previously described.

In some aspects, the signaling diagram 700 may further include additional actions similar to the actions 624-628 of the signaling diagram 600 described previously. In that regard, the NG-RAN 705b may transmit the report received from the UE 115 to the NG-RAN 705a. In some aspects, this may be accomplished via various core network components, such an MME or AMF. In some aspects, the NG-RAN BS 705b may communicate with the NG-RAN BS 704a directly. As previously described with reference to FIG. 6, the NG-RAN BS 705a may use the information received within the report to optimize communication or handover procedures in any of the ways previously described.

As described with reference to the signaling diagram 600 with reference to FIG. 6, the signaling diagram 700 shown in FIG. 7 may correspond to a dual-connectivity scenario. For example, the NG-RAN 705a may be a master node and the NG-RAN 705b may be a secondary node. In that regard, the NG-RAN 705b may be in communication with the NG-RAN BS 705a and/or the E-UTRAN BS 725. In that regard, the signaling diagram 700 may correspond to a communication scenario in which both the master node and the secondary node are NR cells (e.g., NR-DC).

In a dual-connectivity scenario, the UE 115 may be in communication with both the NG-RAN BS 705a as a master node and the NG-RAN 705b as a secondary node simultaneously. In such a scenario, the NG-RAN BS 705b may not need to send an information request (e.g., at action 716). Rather, the UE 115 may be configured to automatically generate the report (e.g., at action 720) and transmit the report to the NG-RAN BS 705b (e.g., at action 722). In such a scenario processing time and computational resources may be preserved. In this scenario, the report generated at action 720 may be referred to as or include master cell group (MCG) failure information and may include any of the types of fallback information described herein. The NG-RAN BS 705b may then transmit the report, including MCG failure information and/or the fallback indication to the NG-RAN 705a. The NG-RAN 705a may then perform any of the optimization procedures described herein to improve communication quality and efficiency. In some aspects, an optimization procedure performed by the NG-RAN 705a may include selecting a different secondary node.

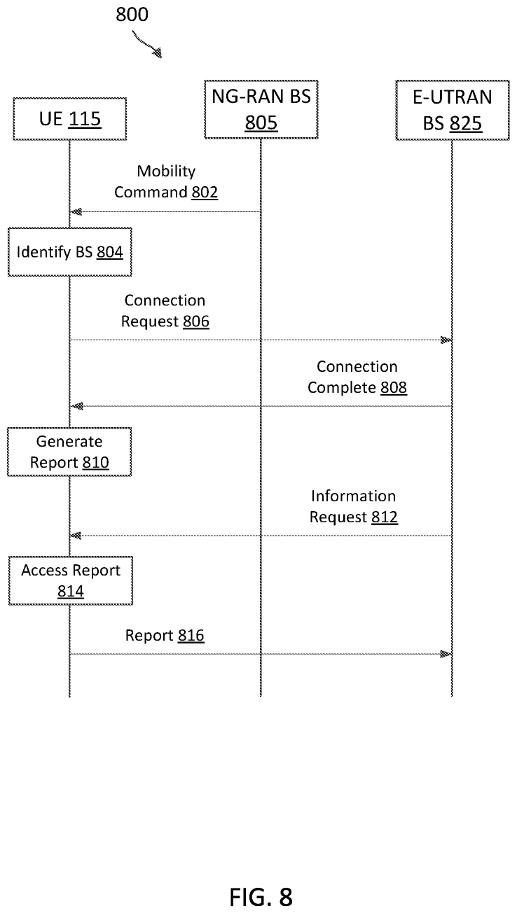

FIG. 8 is a signaling diagram 800 of communication between a UE 115, an NG-RAN BS 805, and an E-UTRAN BS 825, according to aspects of the present disclosure. The signaling diagram 800 may illustrate various communications scenarios in which different types of reports may be generated and transmitted from the UE 115 to the E-UTRAN BS 825, and subsequently, either directly or indirectly transmitted to the NG-RAN BS 805. The signaling diagram 800 may be implemented by any suitable wireless communications devices. In some aspects, the UE 115 may utilize one or more components, such as the processor 302, the memory 304, the reporting module 308, the transceiver 310, the modem 312, and one or more antennas 316 shown in FIG. 3 to perform any of the actions of the signaling diagram 800. In some aspects, the NG-RAN BS 805 may be similar to the BS 105 and/or the BS 400 described previously. For example, the NG-RAN BS 805 may utilize one or more components, such as the processor 402, the memory 404, the reporting module 408, the transceiver 410, the modem 412, and the one or more antennas 414 shown in FIG. 4. In some aspects, the E-UTRAN BS 825 may be similar to the BS 105 and/or the BS 400 described previously. For example, E-UTRAN BS 825 may utilize one or more components, such as the processor 402, the memory 404, the reporting module 408, the transceiver 410, the modem 412, and the one or more antennas 414 shown in FIG. 4. As illustrated, the signaling diagram 800 includes a number of enumerated actions, but aspects of FIG. 8 may include additional actions before, after, and between the enumerated actions. In some aspects, one or more of the enumerated actions may be omitted, combined together, or performed in a different order.

It is noted that any of the actions 802-816 of the signaling diagram 800 may be performed with respect to a UE (e.g., UE 115) in a connected or idle mode. In that regard, the signaling diagram 800 may correspond to a handover procedure or a redirection procedure.

At action 802, the NG-RAN BS 805 may transmit a mobility command to the UE 115. The NG-RAN BS 805 may be a 5G base station, including a stand-alone or non-stand-alone BS. The mobility command described with reference to action 802 may be substantially similar to the mobility command 210 described with reference to FIG. 2 and/or action 802 described with reference to FIG. 8. The mobility command of action 802 may initiate an inter-system fallback in which communication between the UE 115 and the NG-RAN BS 805 is terminated, and communication between the UE 115 and the E-UTRAN BS 825 is established.

In some aspects, the mobility command of action 802 may include a mobility from NR command message and may include various fallback indications, including fallback indications relating to voice, emergency services, load balancing, or coverage issues. In some aspects, the mobility command may include various data including a target RAT type and/or other data relating to the target RAT, such as a message container.

At action 804, the UE 115 may identify a target BS. In some aspects, action 804 may additionally include storing the information from the mobility command 802 in a memory of the UE 115. For example, at action 804, the UE 115 may store the fallback indication included in the mobility command 802 specifying whether the fallback relates to a voice fallback, an emergency fallback, or a fallback related to load balancing or coverage. In some aspects, UE 115 may store data such as an indication of a target RAT, a type of target RAT, or a message or message container related to the target RAT. In some aspects, the information from the mobility command may be stored in a variable. The UE 115 may identify a target RAT in any suitable way. For example, the UE 115 may identify a target RAT at action 804 based on a RAT specified by the BS 805 within the mobility command 802. In some aspects, the UE 115 may select a target RAT based on a type of RAT specified by the BS 805 within the mobility command 802.

At action 806, the UE 115 transmits a connection request to the E-UTRAN BS 825. In some aspects, the connection request may include a RACH request.

At action 808, the UE 115 may determine that the connection between the UE 115 and the E-UTRAN BS 825 was successfully established. In some aspects, the E-UTRAN BS 825 may transmit an indication that the connection between the UE 115 and the E-UTRAN BS 825 was successfully established. In some aspects, the UE 115 may determine that the connection between the UE 115 and the E-UTRAN BS 825 was successful in any other way.

At action 810, the UE 115 generates a report. The report generated at action 810 may be any suitable type of report and may contain any suitable information. For example, the report may include metrics related to a channel quality between the UE 115 and the E-UTRAN BS 825 and/or the NG-RAN BS 805, biographical information relating to the connection request or the completed connection between the UE 115 and the E-UTRAN BS 825, such as a time of the request or completed connection, contents of the request or an indication of the completed connection, or other specified parameters or any other information. In some aspects, the report generated at action 810 may include any of the information included in the mobility command of action 802 described previously. In some aspects, the report may additionally include the fallback indication. For example, the report of action 810 may include a fallback indication which specifies a cause of the fallback procedure. In that regard, the report generated at action 810 may include voice fallback indication, an emergency fallback indication, a load balancing fallback indication, and/or a coverage fallback indication.

In some aspects, the report generated at action 810 including the fallback indication may be a report of any suitable type. For example, the repot of action 810 may be a RACH report if the successful RACH between the UE 115 and the E-UTRAN BS 825 was due to an inter-system handover triggered due to EPS fallback or successful redirection from NR with voice fallback. In some aspects, the report of action 810 may be a successful handover report if the previous successful handover is due to an inter-system handover triggered due to EPS fallback. In some aspects, the report of action 810 may be a mobility history report if the mobility is due to an inter-system handover triggered due to EPS fallback. In that regard, the report generated at action 810 may be a RACH report, a successful handover report, or a mobility history report, each of these reports may include the fallback indication of any suitable type including any of those listed previously. In some aspects, the report generated at action 810 may additionally or alternatively be an RLF report (e.g., in aspects in which the UE 115 is an RRC connected mode) or a CEF report (e.g., in aspects in which the UE 115 is in an RRC idle mode). In some aspects, the report generated at action 810 may include a successful handover report (SHR).

In aspects in which the report of action 810 includes an RLF report, SHR, or CEF report, the UE 115 may prioritize reporting radio measurements of neighboring E-UTRA cells within the report for the E-UTRAN BS 825.

At action 812, the E-UTRAN BS 825 may transmit a request for information to the UE 115. In some aspects, the E-UTRAN BS 825 may transmit the request for information to the UE 115 in response to a connection being established between the UE 115 and the E-UTRAN BS 825. The request for information may specify any suitable information. For example, the request for information may include a request for the report generated at action 810. In some aspects, the request for information may include information related to previous failed connection attempts, or information related to the mobility command from prior BS s. In some aspects, the request for information may include a request for information from the mobility command 802.

At action 814, the UE 115 may access the report generated at action 810. In some aspects, the UE 115 may access the memory of the UE 115 and retrieve the requested report or information.

At action 816, the report generated at action 810 may be transmitted to the E-UTRAN BS 825. This report may be transmitted in any suitable way or according to any wireless communication scheme or schedule. In some aspects, the E-UTRAN BS 825 may be configured to transmit an indication to the UE 115 that the report was successfully received in response to receiving the report at action 816. In that regard, the UE 115 may be configured to receive the indication. The UE 115 may then discard or otherwise delete the report from the memory of the UE 115 in response to receiving this indication that the report was successfully received by the E-UTRAN BS 825. In some aspects, the UE 115 may determine that report was successfully received in any other way. In some aspects, it may be determined that the report was successfully transmitted and received as confirmed by lower layers.

In some aspects, the signaling diagram 800 may further include additional actions similar to the actions 624-628 of the signaling diagram 600 described previously. In that regard, the E-UTRAN BS 825 may be configured to transmit an eNB configuration to an MME in communication with the E-UTRAN BS 825. The MME may then transmit a N26 message to an AMF in communication with the NG-RAN BS 805. The AMF may then transmit the report generated at action 810, or select information within the report of action 810, to the NG-RAN BS 805. As previously described with reference to FIG. 6, the NG-RAN BS 805 may use the information received from the AMF to optimize communication or handover procedures in any of the ways previously described.

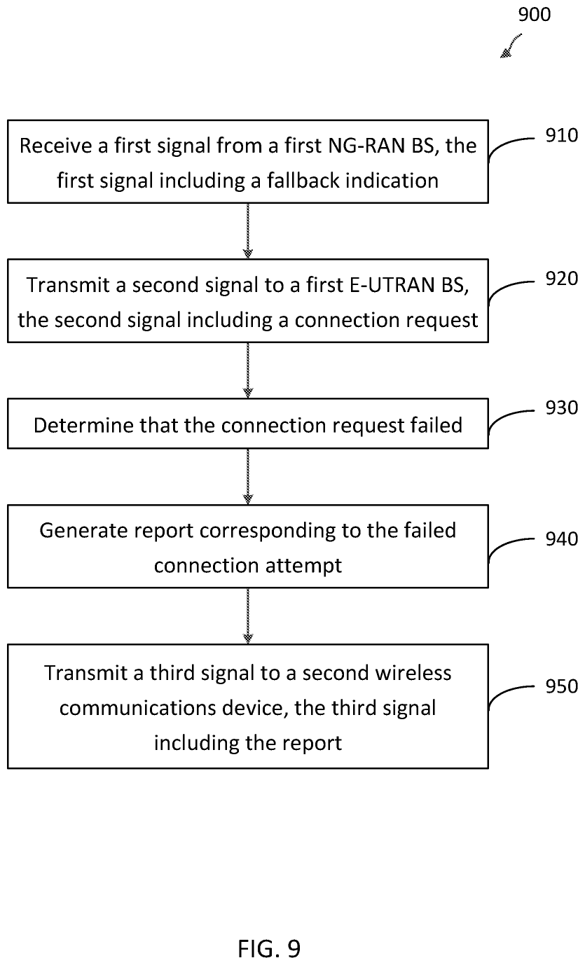

FIG. 9 is a flow diagram of a wireless communication method 900, according to some aspects of the present disclosure. Aspects of the method 900 can be executed by a computing device (e.g., a processor, processing circuit, and/or other suitable component) of a wireless communications device or other suitable means for performing the aspects. For example, a wireless communications device, such as the UE 300, may utilize one or more components, such as the processor 302, the memory 304, the reporting module 308, the transceiver 310, the modem 312, and/or the antennas 316 to execute aspects of method 900. The method 900 may employ similar mechanisms as the actions described with respect to FIGS. 5-8. As illustrated, the method 900 includes a number of enumerated aspects, but the method 900 may include additional aspects before, after, and/or in between the enumerated aspects. In some aspects, one or more of the enumerated aspects may be omitted or performed in a different order.

At block 910, the method 900 includes receiving a first signal from a first NG-RAN BS, the first signal including a fallback indication. In some aspects, the first signal may be a mobility command. In some aspects, a UE may disconnect from wireless communication with the first NG-RAN BS in response to receiving the first signal. In some aspects, the first signal may be an RRC release signal, or any other suitable command signal. In some aspects, the first signal may include a fallback indication. The fallback indication may designate the type of fallback which may correspond to the mobility command of the first signal. In some aspects, the fallback indication may be included in the mobility command. In other aspects, the UE may generate and/or otherwise determine the fallback indication.

At block 920, the method 900 includes transmitting a second signal to a first E-UTRAN BS, the second signal including a connection request. In some aspects, the UE may perform a search for additional cells or BSs within range of the UE. As a result of the search, the UE may identify a BS. In some aspects, the BS may be an E-UTRAN BS. The second signal transmitted by the UE to the first E-UTRAN BS may include a connection request, such as a RACH request. In some aspects, as described with reference to FIGS. 6-7 previously, the UE may identify a target BS based on an indication of a target BS or a type of a BS received in the mobility command.

At block 930, the method 900 includes determining that the connection request failed. In some aspects, the UE may determine that the connection attempt with the first E-UTRAN BS may have failed in response to not receiving a response from the first E-UTRAN BS. In some aspects, the UE may specify a time limit during which the UE must receive a response in order to verify that a connection has been established. In some aspects, the UE may additionally store information related to the failed connection request.

At block 940, the method 900 includes generating a report corresponding to the failed connection attempt. In some aspects, the report generated at block 940 may include any of the information stored by that UE at block 930. For example, the report may include any of the information described with reference to action 610 of FIG. 6. In some aspects, the report may additionally include information received by the UE from the first NG-RAN. For example, information of the report may include the first signal received by the UE. In some aspects, the UE may additionally perform a second search for cell or BSs within the range of the UE. In doing so, the UE may identify an alternate BS. In some aspects, the alternate BS maybe a second E-UTRAN BS or may be a second NG-RAN BS. Upon identifying an alternate BS, the UE may transmit a connection request to the alternate BS. The connection request may be similar to the connection request described with reference to block 920.

At block 950, the method 900 includes transmitting a third signal to a second wireless communications device, the third signal including the report. In some aspects, the UE may transmit the third signal in response to receiving an information request from the second wireless communications device. In some aspects, the third signal may include the report of block 940 as well as any other suitable information. In response to receiving the report, the second wireless communications device may transfer information from the report to the first NG-RAN described with reference to block 910. This may be accomplished in any suitable way. For example, the second wireless communications device may transfer aspects of the report to components of a core network in communication with the second wireless communications device. In some aspects, the second wireless communications device may transfer aspects of the report to the NG-RAN BS of block 910 directly.

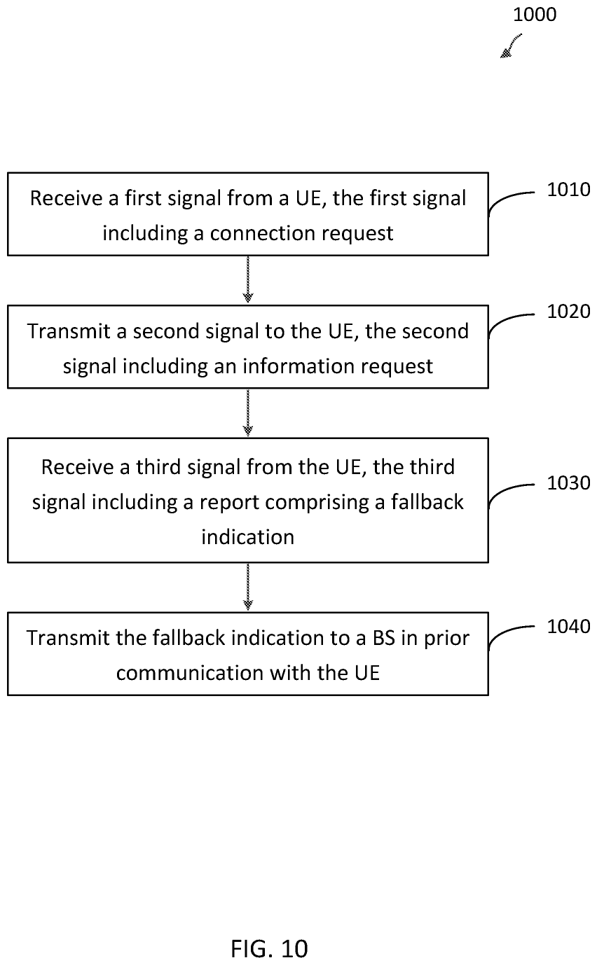

FIG. 10 is a flow diagram of a wireless communication method 1000, according to some aspects of the present disclosure. Aspects of the method 1000 can be executed by a computing device (e.g., a processor, processing circuit, and/or other suitable component) of a wireless communications device or other suitable means for performing the aspects. For example, a wireless communications device, such as the BS 400, may utilize one or more components, such as the processor 402, the memory 404, the reporting module 408, the transceiver 410, the modem 412, and/or the antennas 416 to execute aspects of method 1000. The method 1000 may employ similar mechanisms as the actions described with respect to FIGS. 5-8. As illustrated, the method 1000 includes a number of enumerated aspects, but the method 1000 may include additional aspects before, after, and/or in between the enumerated aspects. In some aspects, one or more of the enumerated aspects may be omitted or performed in a different order.

At block 1010, the method 1000 includes receiving a first signal from a UE, the first signal including a connection request. In some aspects, the UE may transmit the connection request in response to having disconnected from a BS as part of a fallback procedure. In addition, the UE may have attempted to connect to E-UTRAN BS previously. However, this connection attempt may have failed. In that respect, the connection request received at block 1010 may be a request from the UE to connect to an alternate BS to replace the originally identified E-UTRAN BS with which connection was not established.

At block 1020, the method 1000 includes transmitting a second signal to the UE, the second signal including an information request. In some aspects, block 1020 may include transmitting the request for information to the UE in response to a connection being established between the UE and the alternate E-UTRAN BS identified at block 1010. The request for information may specify any suitable information. For example, the request for information may include a request for information related to any previous failed connection attempts, or information related to the mobility command from prior B Ss. In some aspects, the request for information may include a request for information from a prior mobility command received by the UE.

At block 1030, the method 1000 includes receiving a third signal from the UE, the third signal including a report comprising a fallback indication. In some aspects, the report may be based on, or include, any of the information requested at block 1020. In some aspects, the report received may include a radio link failure (RLF) report. The RLF report may include any suitable data. In some aspects, the RLF report may include any of the data or types of data shown and described with reference to FIG. 5. Notably, the RLF report may include the fallback indication. Referring to FIG. 5, the fallback indication may correspond to a voice fallback indication. In some aspects, the RLF report may additionally or alternatively include fallback indications of different types, such as an emergency fallback indication, a fallback indication due to load balancing, a fallback indication due to coverage issues, or any other type of fallback indication.

In some aspects, the report generated at action 620 may include an indication of an NG-RAN BS in prior communication with the BS. In some aspects, a field of the report may indicate the PCell in which an RLF was detected and/or the source PCell of a failed handover. The report may include a field in which a measurement result is included and set to a value of an RLF report. In some aspects, the report may include a time that has elapsed since the last radio link failure or handover failure.

At block 1040, the method 1000 includes transmitting the fallback indication to a BS in prior communication with the UE. In that regard, report received from the UE may be transmitted to the NG-RAN in prior communication with the UE, for example, which initiated the fallback procedure. In some aspects, this may be accomplished via various core network components, such an MME or AMF. the NG-RAN BS may use the information received within the report to optimize communication or handover procedures in any of the ways previously described.

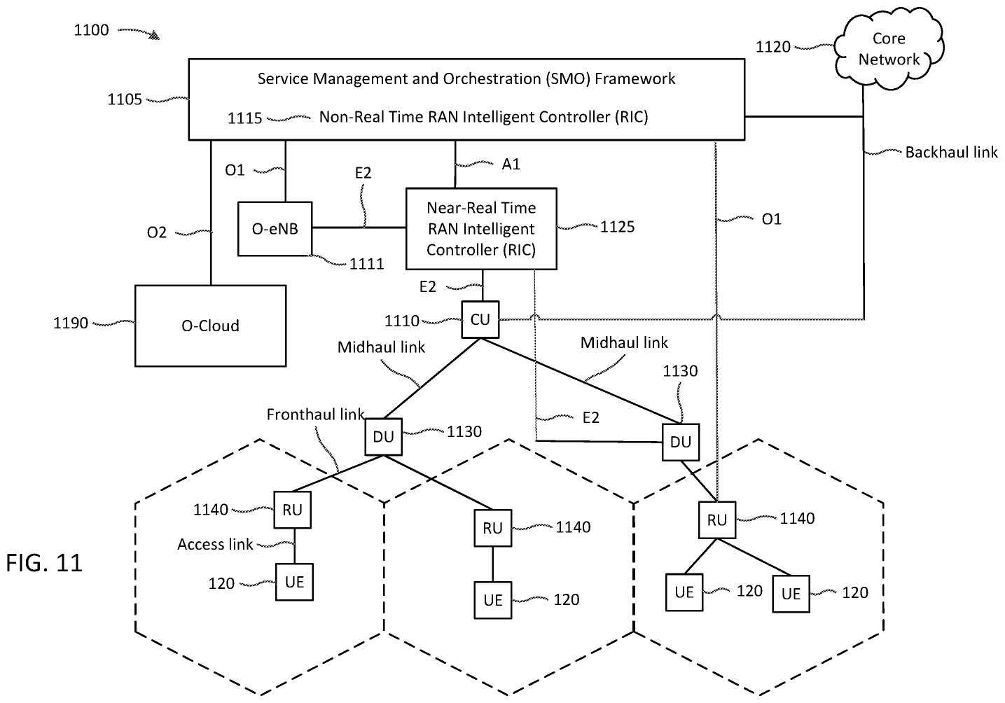

FIG. 11 shows a diagram illustrating an example disaggregated base station 1100 architecture. The disaggregated base station 1100 architecture may include one or more central units (CUs) 1110 that can communicate directly with a core network 1120 via a backhaul link, or indirectly with the core network 1120 through one or more disaggregated base station units (such as a Near-Real Time (Near-RT) RAN Intelligent Controller (RIC) 1125 via an E2 link, or a Non-Real Time (Non-RT) RIC 1115 associated with a Service Management and Orchestration (SMO) Framework 1105, or both). A CU 1110 may communicate with one or more distributed units (DUs) 1130 via respective midhaul links, such as an F1 interface. The DUs 1130 may communicate with one or more radio units (RUs) 1140 via respective fronthaul links. The RUs 1140 may communicate with respective UEs 120 via one or more radio frequency (RF) access links. In some implementations, the UE 120 may be simultaneously served by multiple RUs 1140. Aspects of the present disclosure described as occurring at, or controlled by, a BS may occur at any one or more of these different units.

Each of the units, i.e., the CUs 1110, the DUs 1130, the RUs 1140, as well as the Near-RT RICs 1125, the Non-RT RICs 1115 and the SMO Framework 1105, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 1110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 1110. The CU 1110 may be configured to handle user plane functionality (i.e., Central Unit-User Plane (CU-UP)), control plane functionality (i.e., Central Unit-Control Plane (CU-CP)), or a combination thereof. In some implementations, the CU 1110 can be logically split into one or more CU-UP units and one or more CU-CP units. The CU-UP unit can communicate bidirectionally with the CU-CP unit via an interface, such as the E1 interface when implemented in an O-RAN configuration. The CU 1110 can be implemented to communicate with the DU 1130, as necessary, for network control and signaling.

The DU 1130 may correspond to a logical unit that includes one or more base station functions to control the operation of one or more RUs 1140. In some aspects, the DU 1130 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 1130 may further host one or more low PHY layers. Each layer (or module) can be implemented with an interface configured to communicate signals with other layers (and modules) hosted by the DU 1130, or with the control functions hosted by the CU 1110.

Lower-layer functionality can be implemented by one or more RUs 1140. In some deployments, an RU 1140, controlled by a DU 1130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 1140 can be implemented to handle over the air (OTA) communication with one or more UEs 120. In some implementations, real-time and non-real-time aspects of control and user plane communication with the RU(s) 1140 can be controlled by the corresponding DU 1130. In some scenarios, this configuration can enable the DU(s) 1130 and the CU 1110 to be implemented in a cloud-based RAN architecture, such as a vRAN architecture.

The SMO Framework 1105 may be configured to support RAN deployment and provisioning of non-virtualized and virtualized network elements. For non-virtualized network elements, the SMO Framework 1105 may be configured to support the deployment of dedicated physical resources for RAN coverage requirements which may be managed via an operations and maintenance interface (such as an O1 interface). For virtualized network elements, the SMO Framework 1105 may be configured to interact with a cloud computing platform (such as an open cloud (O-Cloud) 1190) to perform network element life cycle management (such as to instantiate virtualized network elements) via a cloud computing platform interface (such as an O2 interface). Such virtualized network elements can include, but are not limited to, CUs 1110, DUs 1130, RUs 1140 and Near-RT RICs 1125. In some implementations, the SMO Framework 1105 can communicate with a hardware aspect of a 4G RAN, such as an open eNB (O-eNB) 1111, via an O1 interface. Additionally, in some implementations, the SMO Framework 1105 can communicate directly with one or more RUs 1140 via an O1 interface. The SMO Framework 1105 also may include a Non-RT RIC 1115 configured to support functionality of the SMO Framework 1105.

The Non-RT RIC 1115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 1125. The Non-RT RIC 1115 may be coupled to or communicate with (such as via an A1 interface) the Near-RT RIC 1125. The Near-RT RIC 1125 may be configured to include a logical function that enables near-real-time control and optimization of RAN elements and resources via data collection and actions over an interface (such as via an E2 interface) connecting one or more CUs 1110, one or more DUs 1130, or both, as well as an O-eNB, with the Near-RT RIC 1125.

In some implementations, to generate AI/ML models to be deployed in the Near-RT RIC 1125, the Non-RT RIC 1115 may receive parameters or external enrichment information from external servers. Such information may be utilized by the Near-RT RIC 1125 and may be received at the SMO Framework 1105 or the Non-RT RIC 1115 from non-network data sources or from network functions. In some examples, the Non-RT RIC 1115 or the Near-RT RIC 1125 may be configured to tune RAN behavior or performance. For example, the Non-RT RIC 1115 may monitor long-term trends and patterns for performance and employ AI/ML models to perform corrective actions through the SMO Framework 1105 (such as reconfiguration via O1) or via creation of RAN management policies (such as A1 policies).

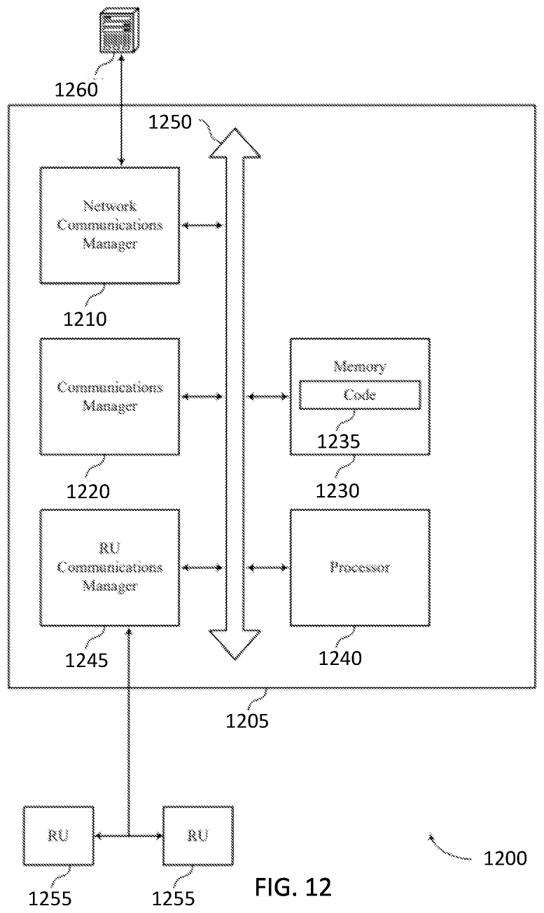

FIG. 12 shows a diagram of a system 1200 including a device 1405 that supports RU sharing techniques in wireless communications in accordance with aspects of the present disclosure. The device 1405 may communicate with one or more RUs 1255. The device 1405 may include components for bi-directional voice and data communications including components for transmitting and receiving communications, such as a communications manager 1220, a network communications manager 1210, a memory 1230, code 1235, a processor 1240, and a RU communications manager 1245. These components may be in electronic communication or otherwise coupled (e.g., operatively, communicatively, functionally, electronically, electrically) via one or more buses (e.g., a bus 1250). One or more of the components of system 1200 may perform functions as described herein with reference to FIGS. 5-10, for example functions described as performed by a base station or network unit.

The network communications manager 1210 may manage communications with a core network 1260 (e.g., via one or more wired backhaul links). For example, the network communications manager 1210 may manage the transfer of data communications for client devices, such as one or more UEs 115.

The memory 1230 may include RAM and ROM. The memory 1230 may store computer-readable, computer-executable code 1235 including instructions that, when executed by the processor 1240, cause the device 1405 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1405 to perform various functions (e.g., functions or tasks supporting RU sharing techniques in wireless communications). For example, the device 1405 or a component of the device 1405 may include a processor 1240 and memory 1230 coupled to the processor 1240, the processor 1240 and memory 1230 configured to perform various functions described herein.

The RU communications manager 1245 may manage communications with RUs 1255 and may include a controller or scheduler for controlling communications with UEs 115 in cooperation with RUs 1255. For example, the RU communications manager 1245 may coordinate scheduling for transmissions to UEs 115. In some examples, the RU communications manager 1245 may provide an F1 interface within a wireless communications network technology to provide communication with RUs 1255.

The communications manager 1220 may support wireless communications at a network node in accordance with examples as disclosed herein. For example, the communications manager 1220 may be configured as or otherwise support a means for transmitting, to a first RU, a request for a wireless resource configuration for a first time period. The communications manager 1220 may be configured as or otherwise support a means for transmitting, to a second RU, an interference inquiry associated with the wireless resource configuration for the first time period. The communications manager 1220 may be configured as or otherwise support a means for receiving, from the second RU, a response to the interference inquiry. The communications manager 1220 may be configured as or otherwise support a means for transmitting, based on the response to the interference inquiry, a payload to the first RU for transmission during the first time period.

By including or configuring the communications manager 1220 in accordance with examples as described herein, the device 1405 may support techniques for RU sharing in which DUs of different MNOs may access wireless resources of other MNOs, which may increase efficiency of resource usage while provide for competition and innovation among different MNOs, may increase the reliability of wireless communications, decrease latency, and enhance user experience.

In some examples, the communications manager 1220 may be configured to perform various operations (e.g., receiving, monitoring, transmitting) using or otherwise in cooperation with other components. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1405 to perform various aspects of RU sharing techniques in wireless communications as described herein, or the processor 1240 and the memory 1230 may be otherwise configured to perform or support such operations.

Further aspects of the present disclosure include the following:

Aspect 1 includes a method of wireless communication, comprising: receiving a first signal by a first wireless communications device from a first next generation radio access network (NG-RAN) base station, the first signal including a fall back indication; in response to receiving the first signal, transmitting a second signal by the first wireless communications device to a first evolved-universal mobile telecommunications system terrestrial radio access network (E-UTRAN) base station, the second signal including a connection request; and transmitting a third signal by the first wireless communications device to a second wireless communications device, the third signal including a report in response to a connection failure with the first E-UTRAN base station.

Aspect 2 includes the method of aspect 1, wherein the report includes a flag configured to be set to a true value in response to failing to establish the connection with the first E-UTRAN base station was due to voice fallback and set to a false value in response to failing to establish the connection with the first E-UTRAN base station was not due to voice fallback.

Aspect 3 includes the method of any of aspects 1-2, wherein the report comprises: a first field corresponding to a handover report type, wherein the handover report type of the report is set to EPS fallback failure in response to the fallback indication indicating a voice fallback; and a second field corresponding to the fallback indication.

Aspect 4 includes the method of any of aspects 1-3, wherein the second wireless communications device is a second E-UTRAN base station.

Aspect 5 includes the method of any of aspects 1-4, wherein the second wireless communications device is a second NG-RAN base station.

Aspect 6 includes the method of any of aspects 1-5, further comprising: searching for the second wireless communications device in response to failing to establish the connection with the first E-UTRAN base station, wherein the report includes an indication that a second E-UTRAN base station was not identified by the searching.

Aspect 7 includes the method of any of aspects 1-6, wherein the report includes a cell global identity (CGI) of the first NG-RAN base station or the first E-UTRAN base station.

Aspect 8 includes the method of any of aspects 1-7, wherein the report includes an indication of time elapsed from a previous radio link failure.

Aspect 9 includes the method of any of aspects 1-8, further comprising: discarding the report after transmitting the third signal.

Aspect 10 includes the method of any of aspects 1-9, wherein: the first wireless communications device is in an active state, and the report is a radio link failure (RLF) report.

Aspect 11 includes the method of any of aspects 1-10, wherein: the wireless communications device is in an idle state, and the report is a connection establishment (CEF) report.

Aspect 12 includes the method of any of aspects 1-11, wherein a random-access channel (RACH) report comprises the report in response to a successful RACH after a handover or redirection from the first NG-RAN base station.

Aspect 13 includes the method of any of aspects 1-12, further comprising transmitting, by the first wireless communications device, an indication of handoff interruption time.

Aspect 14 includes the method of any of aspects 1-13, further comprising transmitting, by the first wireless communications device, an indication of time between an RRC release and a successful RACH corresponding to the second wireless communications device.

Aspect 15 includes the method of any of aspects 1-14, wherein the report includes a successful handoff report.

Aspect 16 includes the method of any of aspects 1-15, wherein the report includes a mobility history report.

Aspect 17 includes the method of any of aspects 1-16, wherein the report is selected and generated based on the first wireless communications device prioritizing neighboring cells.

Aspect 18 includes the method of any of aspects 1-17, wherein the fallback indication corresponds to a voice fallback.

Aspect 19 includes the method of any of aspects 1-18, wherein the fallback indication corresponds to an emergency fallback.

Aspect 20 includes a method of wireless communications, comprising: receiving a first signal by a first wireless communications device from a user equipment (UE), the first signal including a connection request; transmitting a second signal by the first wireless communications device to the UE, the second signal including an information request; receiving a third signal by the first wireless communications device from the UE, the third signal including a report generated in response to a failure to establish a connection between the UE and a second wireless communications device, the report comprising a fallback indication.

Aspect 21 includes the method of aspect 20, wherein the report includes a flag configured to be set to a true value in response to the failure to establish the connection between the UE and the second wireless communications device being due to voice fallback and set to a false value in response to the failure to establish the connection between the UE and the second wireless communications device not being due to voice fallback.

Aspect 22 includes the method of any of aspects 20-21, wherein the report further comprises: a first field corresponding to a handover report type, wherein the handover report type of the report is set to EPS fallback failure in response to the fallback indication indicating a voice fallback; and a second field corresponding to the fallback indication.

Aspect 23 includes the method of any of aspects 20-22, wherein the first wireless communications device is an E-UTRAN base station.

Aspect 24 includes the method of any of aspects 20-23, wherein the first wireless communications device is a NG-RAN base station.

Aspect 25 includes the method of any of aspects 20-24, wherein: the second wireless communications device is a first E-UTRAN base station; the first signal is received in response to the failure to establish the connection between the UE and the second wireless communications device; and the report includes an indication that a second E-UTRAN base station was not identified by searching.

Aspect 26 includes the method of any of aspects 20-25, wherein the report includes either a cell global identity (CGI) of a NG-RAN base station in prior communication with the UE or the second wireless communications device.

Aspect 27 includes the method of any of aspects 20-26, wherein the report includes an indication of time elapsed from a previous radio link failure.

Aspect 28 includes the method of any of aspects 20-27, wherein: the UE is in an active state, and the report is a radio link failure (RLF) report.

Aspect 29 includes the method of any of aspects 20-28, wherein: the UE is in an idle state, and the report is a connection establishment (CEF) report.

Aspect 30 includes the method of any of aspects 20-29, wherein a random-access channel (RACH) report comprises the report in response to a successful RACH on the first wireless communications device after a handover or redirection.

Aspect 31 includes the method of any of aspects 20-30, further comprising receiving, by the first wireless communications device, an indication of time between an RRC release and the successful RACH.

Aspect 32 includes the method of any of aspects 20-31, further comprising receiving, by the first wireless communications device, an indication of handoff interruption time.

Aspect 33 includes the method of any of aspects 20-32, wherein the report includes a successful handoff report.

Aspect 34 includes the method of any of aspects 20-33, wherein the report includes a mobility history report.

Aspect 35 includes the method of any of aspects 20-34, wherein the report is selected and generated based on the UE prioritizing neighboring cells.

Aspect 36 includes the method of any of aspects 20-35, wherein the fallback indication corresponds to a voice fallback.

Aspect 37 includes the method of any of aspects 20-36, wherein the fallback indication corresponds to an emergency fallback.

Aspect 38 includes the method of any of aspects 20-37, further comprising transmitting, by the first wireless communications device, the report to one or more components of a core network for delivery to a NG-RAN BS.

Aspect 39 includes the method of any of aspects 20-38, further comprising transmitting, by the first wireless communications device, the report to a NG-RAN BS for communication optimization.

Aspect 40 includes a wireless communications device, comprising: a transceiver; and a processor coupled with the transceiver, wherein the wireless communications device is configured to: receive a first signal from a first next generation radio access network (NG-RAN) base station, the first signal including a fallback indication; in response to receiving the first signal, transmit a second signal to a first evolved-universal mobile telecommunications system terrestrial radio access network (E-UTRAN) base station, the second signal including a connection request; and transmit a third signal to a second wireless communications device, the third signal including a report in response to a connection failure with the first E-UTRAN base station.

Aspect 41 includes the wireless communications device of aspect 40, wherein the report includes a flag configured to be set to a true value in response to failing to establish the connection with the first E-UTRAN base station was due to voice fallback and set to a false value in response to failing to establish the connection with the first E-UTRAN base station was not due to voice fallback.

Aspect 42 includes the wireless communications device of any of aspects 40-41, wherein the report comprises: a first field corresponding to a handover report type, wherein the handover report type of the report is set to EPS fallback failure in response to the fallback indication indicating a voice fallback; and second field corresponding to the fallback indication.

Aspect 43 includes the wireless communications device of any of aspects 40-42, wherein the second wireless communications device is a second E-UTRAN base station.

Aspect 44 includes the wireless communications device of any of aspects 40-43, wherein the second wireless communications device is a second NG-RAN base station.

Aspect 45 includes the wireless communications device of any of aspects 40-44, further configured to: search for the second wireless communications device in response to failing to establish the connection with the first E-UTRAN base station, wherein the report includes an indication that a second E-UTRAN base station was not identified by the searching.

Aspect 46 includes the wireless communications device of any of aspects 40-45, wherein the report includes a cell global identity (CGI) of the first NG-RAN base station or the first E-UTRAN base station.

Aspect 47 includes the wireless communications device of any of aspects 40-46, wherein the report includes an indication of time elapsed from a previous radio link failure.

Aspect 48 includes the wireless communications device of any of aspects 40-47, further configured to: discard the report after transmitting the third signal.

Aspect 49 includes the wireless communications device of any of aspects 40-48, wherein: the wireless communications device is in an active state, and the report is a radio link failure (RLF) report.

Aspect 50 includes the wireless communications device of any of aspects 40-49, wherein: the wireless communications device is in an idle state, and the report is a connection establishment (CEF) report.

Aspect 51 includes the wireless communications device of any of aspects 40-50, wherein a random-access channel (RACH) report comprises the report in response to a successful RACH after a handover or redirection from the first NG-RAN base station.

Aspect 52 includes the wireless communications device of any of aspects 40-51, further configured to transmit an indication of time between an RRC release and the successful RACH corresponding to the second wireless communications device.

Aspect 53 includes the wireless communications device of any of aspects 40-52, further configured to transmit an indication of handoff interruption time.

Aspect 54 includes the wireless communications device of any of aspects 40-53, wherein the report includes a successful handoff report.

Aspect 55 includes the wireless communications device of any of aspects 40-54, wherein the report includes a mobility history report.

Aspect 56 includes the wireless communications device of any of aspects 40-55, further configured to prioritize neighboring cells, and wherein the report is selected and generated based on prioritizing.

Aspect 57 includes the wireless communications device of any of aspects 40-56, wherein the fallback indication corresponds to a voice fallback.

Aspect 58 includes the wireless communications device of any of aspects 40-57, wherein the fallback indication corresponds to an emergency fallback.

Aspect 59 includes a wireless communications device, comprising: a transceiver; and a processor coupled with the transceiver, wherein the wireless communications device is configured to: receive a first signal from a user equipment (UE), the first signal including a connection request; transmit a second signal to the UE, the second signal including an information request; receive a third signal from the UE, the third signal including a report generated in response to a failure to establish a connection between the UE and a second wireless communications device, the report comprising a fallback indication.

Aspect 60 includes the wireless communications device of aspect 59, wherein the report includes a flag configured to be set to a true value in response to the failure to establish the connection between the UE and the second wireless communications device being due to voice fallback and set to a false value in response to the failure to establish the connection between the UE and the second wireless communications device not being due to voice fallback.

Aspect 61 includes the wireless communications device of any of aspects 59-60, wherein the report further comprises: a first field corresponding to a handover report type, wherein the handover report type of the report is set to EPS fallback failure in response to the fallback indication indicating a voice fallback; and a second field corresponding to the fallback indication.

Aspect 62 includes the wireless communications device of any of aspects 59-61, wherein the wireless communications device is an E-UTRAN base station.

Aspect 63 includes the wireless communications device of any of aspects 59-62, wherein the wireless communications device is a NG-RAN base station.

Aspect 64 includes the wireless communications device of any of aspects 59-63, wherein: the second wireless communications device is a first E-UTRAN base station; the wireless communications device is configured to receive the first signal in response to the failure to establish the connection between the UE and the second wireless communications device; and the report includes an indication that a second E-UTRAN base station was not identified by searching.

Aspect 65 includes the wireless communications device of any of aspects 59-64, wherein the report includes either a cell global identity (CGI) of a NG-RAN base station in prior communication with the UE or a second wireless communications device.

Aspect 66 includes the wireless communications device of any of aspects 59-65, wherein the report includes an indication of time elapsed from a previous radio link failure.

Aspect 67 includes the wireless communications device of any of aspects 59-66, wherein: the UE is in an active state, and the report is a radio link failure (RLF) report.

Aspect 68 includes the wireless communications device of any of aspects 59-67, wherein: the UE is in an idle state, and the report is a connection establishment (CEF) report.

Aspect 69 includes the wireless communications device of any of aspects 59-68, wherein a random-access channel (RACH) report comprises the report in response to a successful RACH on the first wireless communications device after a handover or redirection.

Aspect 70 includes the wireless communications device of any of aspects 59-69, further configured to receive an indication of time between an RRC release and the successful RACH.

Aspect 71 includes the wireless communications device of any of aspects 59-70, further configured to receive an indication of handoff interruption time.

Aspect 72 includes the wireless communications device of any of aspects 59-71, wherein the report includes a successful handoff report.

Aspect 73 includes the wireless communications device of any of aspects 59-72, wherein the report includes a mobility history report.

Aspect 74 includes the wireless communications device of any of aspects 59-73, wherein the report is selected and generated based on the UE prioritizing neighboring cells.

Aspect 75 includes the wireless communications device of any of aspects 59-74, wherein the fallback indication corresponds to a voice fallback.

Aspect 76 includes the wireless communications device of any of aspects 59-75, wherein the fallback indication corresponds to an emergency fallback.

Aspect 77 includes the wireless communications device of any of aspects 59-76, further configured to transmit the report to one or more components of a core network for delivery to a NG-RAN BS.

Aspect 78 includes the wireless communications device of any of aspects 59-77, further configured to transmit the report to a NG-RAN BS for communication optimization.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A method of wireless communication, comprising:
receiving a first signal by a first wireless communications device from a first next generation radio access network (NG-RAN) base station, the first signal including a fallback indication;
in response to receiving the first signal, transmitting a second signal by the first wireless communications device to a first evolved-universal mobile telecommunications system terrestrial radio access network (E-UTRAN) base station, the second signal including a connection request; and
transmitting a third signal by the first wireless communications device to a second wireless communications device, the third signal including a report in response to a connection failure with the first E-UTRAN base station.

2. The method of claim 1, wherein the report includes a flag configured to be set to a true value in response to the connection failure with the first E-UTRAN base station being due to voice fallback and set to a false value in response to the connection failure with the first E-UTRAN base station being not due to voice fallback.

3. The method of claim 1, wherein the report comprises:
a first field corresponding to a handover report type, wherein the handover report type of the report is set to EPS fallback failure in response to the fallback indication indicating a voice fallback; and
a second field corresponding to the fallback indication.

4. The method of claim 1, wherein the second wireless communications device is a second E-UTRAN base station or a second NG-RAN base station.

5. The method of claim 4, further comprising:
searching for the second wireless communications device in response to the connection failure with the first E-UTRAN base station, wherein the report includes an indication that a second E-UTRAN base station was not identified by the searching.

6. The method of claim 1, wherein:
the first wireless communications device is in an active state, and
the report is a radio link failure (RLF) report.

7. The method of claim 1, wherein the fallback indication corresponds to a voice fallback.

8. The method of claim 1, wherein the fallback indication corresponds to an emergency fallback.

9. A method of wireless communication, comprising:
receiving a first signal by a first wireless communications device from a user equipment (UE), the first signal including a connection request;
transmitting a second signal by the first wireless communications device to the UE, the second signal including an information request; and
receiving a third signal by the first wireless communications device from the UE, the third signal including a report generated in response to a failure to establish a connection between the UE and a second wireless communications device, the report comprising a fallback indication.

10. The method of claim 9, wherein the report includes a flag configured to be set to a true value in response to the failure to establish the connection between the UE and the second wireless communications device being due to voice fallback and set to a false value in response to the failure to establish the connection between the UE and the second wireless communications device not being due to voice fallback.

11. The method of claim 9, wherein the report further comprises:
a first field corresponding to a handover report type, wherein the handover report type of the report is set to EPS fallback failure in response to the fallback indication indicating a voice fallback; and
a second field corresponding to the fallback indication.

12. The method of claim 9, wherein the first wireless communications device is an E-UTRAN base station or a second NG-RAN base station.

13. The method of claim 12, wherein:
the second wireless communications device is a first E-UTRAN base station;
the first signal is received in response to the failure to establish the connection between the UE and the second wireless communications device; and
the report includes an indication that a second E-UTRAN base station was not identified by searching.

14. The method of claim 9, wherein:
the UE is in an active state, and
the report is a radio link failure (RLF) report.

15. The method of claim 9, wherein the fallback indication corresponds to an emergency fallback.

16. A wireless communications device, comprising:
a transceiver; and
a processor coupled with the transceiver, wherein the wireless communications device is configured to:
receive a first signal from a first next generation radio access network (NG-RAN) base station, the first signal including a fallback indication;
in response to receiving the first signal, transmit a second signal to a first evolved-universal mobile telecommunications system terrestrial radio access network (E-UTRAN) base station, the second signal including a connection request; and
transmit a third signal to a second wireless communications device, the third signal including a report in response to a connection failure with the first E-UTRAN base station.

17. The wireless communications device of claim 16, wherein the report includes a flag configured to be set to a true value in response to the connection failure with the first E-UTRAN base station being due to voice fallback and set to a false value in response to the connection failure with the first E-UTRAN base station being not due to voice fallback.

18. The wireless communications device of claim 16, wherein the report comprises:
a first field corresponding to a handover report type, wherein the handover report type of the report is set to EPS fallback failure in response to the fallback indication indicating a voice fallback; and
a second field corresponding to the fallback indication.

19. The wireless communications device of claim 16, wherein the second wireless communications device is a second E-UTRAN base station or a second NG-RAN base station.

20. The wireless communications device of claim 19, further configured to:
search for the second wireless communications device in response to the connection failure with the first E-UTRAN base station, wherein the report includes an indication that a second E-UTRAN base station was not identified by the searching.

21. The wireless communications device of claim 16, wherein:
the wireless communications device is in an active state, and
the report is a radio link failure (RLF) report.

22. The wireless communications device of claim 16, wherein the fallback indication corresponds to a voice fallback.

23. The wireless communications device of claim 16, wherein the fallback indication corresponds to an emergency fallback.

24. A wireless communications device, comprising:
a transceiver; and
a processor coupled with the transceiver, wherein the wireless communications device is configured to:
receive a first signal from a user equipment (UE), the first signal including a connection request;
transmit a second signal to the UE, the second signal including an information request; and
receive a third signal from the UE, the third signal including a report generated in response to a failure to establish a connection between the UE and a second wireless communications device, the report comprising a fallback indication.

25. The wireless communications device of claim 24, wherein the report includes a flag configured to be set to a true value in response to the failure to establish the connection between the UE and the second wireless communications device being due to voice fallback and set to a false value in response to the failure to establish the connection between the UE and the second wireless communications device not being due to voice fallback.

26. The wireless communications device of claim 24, wherein the report further comprises:
a first field corresponding to a handover report type, wherein the handover report type of the report is set to EPS fallback failure in response to the fallback indication indicating a voice fallback; and
a second field corresponding to the fallback indication.

27. The wireless communications device of claim 24, wherein the wireless communications device is an E-UTRAN base station or a second NG-RAN base station.

28. The wireless communications device of claim 24, wherein:
the second wireless communications device is a first E-UTRAN base station;
the wireless communications device is configured to receive the first signal in response to the failure to establish the connection between the UE and the second wireless communications device; and
the report includes an indication that a second E-UTRAN base station was not identified by searching.

29. The wireless communications device of claim 24, wherein:
the UE is in an active state, and
the report is a radio link failure (RLF) report.

30. The wireless communications device of claim 24, wherein the fallback indication corresponds to an emergency fallback.
